(19) United States
(12) Patent Application Publication
(10) Pub. No.: US 2026/0278568 A1
(43) Pub. Date: Sep. 17, 2026

(54) DEVICES, SYSTEMS, AND METHODS FOR SEAMLESSLY INTEGRATING AND FACILITATING THE USE OF FIAT AND DIGITAL ASSETS

(71) Applicant: Visa International Service Association, San Francisco, CA (US)

(72) Inventors: Shweta Naik, Redwood City, CA (US); Madhvesh Navkal BADRI, Dublin, CA (US)

(73) Assignee: Visa International Service Association, San Francisco, CA (US)

(21) Appl. No.: 19/472,355

(22) PCT Filed: Apr. 11, 2023
(86) PCT No.: PCT/US2023/018139

§ 371 Date: Oct. 3, 2025

(51) Int. Cl. G06Q 20/06; G06Q 20/22; G06Q 20/36; G06Q 20/38

(52) U.S. Cl. CPC G06Q 20/065; G06Q 20/227; G06Q 20/36; G06Q 20/385; G06Q 2220/00

(57) ABSTRACT

A computer-implemented method is disclosed herein. The method includes receiving cryptocurrency account information associated with a digital asset account hosted by a cryptocurrency exchange, generating a token associated with the cryptocurrency account information, receiving a unique identifier from an issuer system, wherein the unique identifier is associated with a fiat-based asset account hosted by the issuer system, linking the token to the unique identifier, and storing the token in a token vault of the payment network. The method can further include displaying the cryptocurrency account information and the fiat-based account information based on the token via a user device to display. The method can further include generating a machine-readable code associated with the token based on a user input, wherein the machine-readable code initiates a transaction authorization request based on the cryptocurrency account information and the fiat-based account information when registered by an acceptance device.

### TECHNICAL FIELD

The present disclosure is generally related to payment networks and, more particularly, is directed to a payment system configured to access and display information associated with multiple financial accounts of a user, and to enable streamlined payments from any of those financial accounts.

### SUMMARY

In one aspect, the present disclosure provides a computer-implemented method. The method can include receiving cryptocurrency account information associated with a digital asset account hosted by a cryptocurrency exchange, generating a token associated with the cryptocurrency account information, receiving a unique identifier from an issuer system, wherein the unique identifier is associated with a fiat-based asset account hosted by the issuer system, linking the token to the unique identifier, and storing the token in a token vault of the payment network. The method can further include displaying the cryptocurrency account information and the fiat-based account information based on the token via a user device to display. The method can further include generating a machine-readable code associated with the token based on a user input, wherein the machine-readable code initiates a transaction authorization request based on the cryptocurrency account information and the fiat-based account information when registered by an acceptance device.

In another aspect, a payment network communicably coupled to a plurality of financial institution systems is disclosed. The plurality of financial institution systems can include a cryptocurrency exchange configured to host a digital asset account, and an issuer system configured to host a fiat-based asset account. The payment network can include a tokenization engine configured to receive cryptocurrency account information associated with the digital asset account from the cryptocurrency exchange, generate a token associated with the cryptocurrency account information, receive a unique identifier associated with the fiat-based asset account hosted by the issuer system, link the token to the unique identifier. The payment network can further include a token vault configured to receive the token from the tokenization engine, and store the token.

In still other aspects, a system is disclosed. The system can include a payment network communicably coupled to a plurality of financial institution systems, wherein the plurality of financial institution systems include a cryptocurrency exchange configured to host a digital asset account. The system can further include an issuer system configured to host a fiat-based asset account. The payment network can be configured to receive cryptocurrency account information associated with the digital asset account from the cryptocurrency exchange, generate a token associated with the cryptocurrency account information, receive a unique identifier associated with the fiat-based asset account hosted by the issuer system, link the token to the unique identifier, and store the token. The system can further include a financial mobile application, installable on a user device including a processor and a memory. The financial mobile application can include an application program interface communicably couplable to the payment network, wherein the API is configured to cause the user device to receive the token from the payment network, display the cryptocurrency account information based on the token, and display fiat-based account information based on the token, wherein the account information is associated with the unique identifier.

### BRIEF DESCRIPTION OF THE DRAWINGS

In the description, for purposes of explanation and not limitation, specific details are set forth, such as particular aspects, procedures, techniques, etc. to provide a thorough understanding of the present technology. However, it will be apparent to one skilled in the art that the present technology may be practiced in other aspects that depart from these specific details.

The accompanying drawings, where like reference numerals refer to identical or functionally similar elements throughout the separate views, together with the detailed description below, are incorporated in and form part of the specification, and serve to further illustrates aspects of concepts that include the claimed disclosure and explain various principles and advantages of those aspects.

The [apparatuses, systems, and methods] disclosed herein have been represented where appropriate by conventional symbols in the drawings, showing only those specific details that are pertinent to understanding the various aspects of the present disclosure so as not to obscure the disclosure with details that will be readily apparent to those of ordinary skill in the art having the benefit of the description herein.

FIG. 1 illustrates a system configured to seamlessly integrate and facilitate the use of fiat and digital assets, according to at least one aspect of the present disclosure;

FIG. 2 illustrates block diagram of a system for implementing a blockchain network configured to interface with the cryptocurrency exchange of the system of FIG. 1, according to at least one aspect of the present disclosure;

FIG. 3 illustrates a block diagram of an architecture configured to be implemented via the system of FIG. 1, according to at least one aspect of the present disclosure;

FIG. 4 illustrates a block diagram of an alternate architecture configured to be implemented via the system of FIG. 1, according to at least one non-limiting aspect of the present disclosure;

FIG. 5 illustrates a representative user interface of the financial mobile application of the system of FIG. 1, according to at least one non-limiting aspect of the present disclosure;

FIG. 6 illustrates a logic flow diagram of a method of seamlessly integrating and facilitating the use of fiat and digital assets is depicted, according to at least one non-limiting aspect of the present disclosure;

FIG. 7 illustrates a block diagram of a computer apparatus, according to at least aspect of the present disclosure; and

FIG. 8 illustrates a diagrammatic representation of an example system that includes a host machine within which a set of instructions to perform any one or more of the methodologies discussed herein may be executed, according to at least one aspect of the present disclosure.

Corresponding reference characters indicate corresponding parts throughout the several views. The exemplifications set out herein illustrate various aspects of the present disclosure, in one form, and such exemplifications are not to be construed as limiting the scope of the claimed subject matter in any manner.

### DESCRIPTION

The following disclosure may provide exemplary systems, devices, and methods for conducting a financial transaction and related activities. Although reference may be made to such financial transactions in the examples provided below, aspects are not so limited.

That is, the systems, methods, and apparatuses may be utilized for any suitable purpose.

Before discussing specific embodiments, aspects, or examples, some descriptions of terms used herein are provided below.

As used herein, the term “acceptance device” may be any suitable device that can accept or initiate a transaction. Non-limiting examples of an acceptance device may include a point-of-sale system, cash register, transaction processing computer, an authentication computer, a computing device, or a merchant server, such as a web server or e-commerce payment gateway configured to receive payment or transaction information. An acceptance device may further contain at least one processor, memory, secure element, speaker, display, wireless radio, card reader, or any other suitable component, or any combination thereof.

Further, the term “account credential,” “account number,” or “payment credential” may refer to any suitable information associated with an account (e.g. a payment account and/or payment device associated with the account). Such information may be directly related to the account or may be derived from information related to the account. Examples of account information may include a PAN (primary account number or “account number”), user name, expiration date, CVV (card verification value), dCVV (dynamic card verification value), CVV2 (card verification value 2), CVC3 card verification values, etc. Payment credentials may be any information that identifies or is associated with a payment account. Payment credentials may be provided in order to make a payment from a payment account. Payment credentials can also include a user name, an expiration date, a gift card number or code, and any other suitable information.

The term “account data,” as used herein, refers to any data concerning one or more accounts for one or more users. Account data may include, for example, one or more account identifiers, user identifiers, transaction histories, balances, credit limits, issuer institution identifiers, and/or the like.

As used herein, the term “account identifier” may refer to one or more types of identifiers associated with an account (e.g., a unique identifier of an account, an account number, a PAN, a card number, a payment card number, a token, and/or the like) of a user. In some non-limiting embodiments or aspects, an issuer may provide an account identifier (e.g., a PAN, a token, a globally unique identifier (GUID), a universally unique identifier (UUID), and/or the like) to a user that uniquely identifies one or more accounts associated with that user. In some non-limiting embodiments or aspects, an account identifier may be embodied on a payment device (e.g., a portable financial instrument, a payment card, a credit card, a debit card, and/or the like) and/or may be electronic information communicated to the user that the user may use for electronic payment transactions. In some non-limiting embodiments or aspects, an account identifier may be an original account identifier, where the original account identifier was provided to a user at the creation of the account associated with the account identifier. In some non-limiting embodiments or aspects, the account identifier may be an account identifier (e.g., a supplemental account identifier) that is provided to a user after the original account identifier was provided to the user. For example, if the original account identifier is forgotten by the user, stolen from the user, and/or the like, a supplemental account identifier may be provided to the user. In some non-limiting embodiments or aspects, an account identifier may be directly or indirectly associated with an issuer such that an account identifier may be a token that maps to a PAN or other type of identifier. Account identifiers may be alphanumeric, any combination of characters and/or symbols, and/or the like.

As used herein, the term “account token,” or “token” may refer to an identifier that is used as a substitute or replacement identifier for an account identifier, such as a PAN. An account token may be used as a substitute or replacement identifier for an original account identifier, such as a PAN. Account tokens may be associated with a PAN or other original account identifier in one or more data structures (e.g., one or more databases and/or the like) such that they may be used to conduct a transaction without directly using the original account identifier. In some non-limiting embodiments or aspects, an original account identifier, such as a PAN, may be associated with a plurality of account tokens for different individuals or purposes. In some non-limiting embodiments aspects, account tokens may be associated with a PAN or other account identifiers in one or more data structures such that they can be used to conduct a transaction without directly using the account identifier, such as a PAN. In some examples, an account identifier, such as a PAN, may be associated with a plurality of account tokens for different uses or different purposes.

An “acquirer” may refer to an entity licensed by the transaction service provider and/or approved by the transaction service provider to originate transactions (e.g., payment transactions) using a portable financial device associated with the transaction service provider. Acquirer may also refer to one or more computer systems operated by or on behalf of an acquirer, such as a server computer executing one or more software applications (e.g., “acquirer server”). An “acquirer” may be a merchant bank, or in some cases, the merchant system may be the acquirer. The transactions may include original credit transactions (OCTs) and account funding transactions (AFTs). The acquirer may be authorized by the transaction service provider to sign merchants of service providers to originate transactions using a portable financial device of the transaction service provider. The acquirer may contract with payment facilitators to enable the facilitators to sponsor merchants. The acquirer may monitor compliance of the payment facilitators in accordance with regulations of the transaction service provider. The acquirer may conduct due diligence of payment facilitators and ensure that proper due diligence occurs before signing a sponsored merchant. Acquirers may be liable for all transaction service provider programs that they operate or sponsor. Acquirers may be responsible for the acts of its payment facilitators and the merchants it or its payment facilitators sponsor.

The term “acquirer” typically is a business entity (e.g., a commercial bank) that has a business relationship with a particular merchant or other entity. Some entities can perform both issuer and acquirer functions. Some embodiments or aspects may encompass such single entity issuer-acquirers. An acquirer may operate an acquirer computer, which can also be generically referred to as a “transport computer”.

As used herein, the term “acquirer system” may also refer to one or more computer systems, computer devices, and/or the like operated by or on behalf of an acquirer. The transactions the acquirer may originate may include payment transactions (e.g., purchases, original credit transactions (OCTs), account funding transactions (AFTs), and/or the like). In some non-limiting embodiments or aspects, the acquirer may be authorized by the transaction service provider to assign merchant or service providers to originate transactions using a portable financial device of the transaction service provider. The acquirer may contract with payment facilitators to enable the payment facilitators to sponsor merchants. The acquirer may monitor compliance of the payment facilitators in accordance with regulations of the transaction service provider. The acquirer may conduct due diligence of the payment facilitators and ensure proper due diligence occurs before signing a sponsored merchant. The acquirer may be liable for all transaction service provider programs that the acquirer operates or sponsors. The acquirer may be responsible for the acts of the acquirer's payment facilitators, merchants that are sponsored by an acquirer's payment facilitator, and/or the like. In some non-limiting embodiments or aspects, an acquirer may be a financial institution, such as a bank.

An “application” may include any software module configured to perform a specific function or functions when executed by a processor of a computer. For example, a “mobile application” may include a software module that is configured to be operated by a mobile device. Applications may be configured to perform many different functions. For instance, a “payment application” may include a software module that is configured to store and provide account credentials for a transaction. A “wallet application” may include a software module with similar functionality to a payment application that has multiple accounts provisioned or enrolled such that they are usable through the wallet application. Further, an “application” or “application program interface” (API) refers to computer code or other data sorted on a computer-readable medium that may be executed by a processor to facilitate the interaction between software components, such as a client-side front-end and/or server-side back-end for receiving data from the client. An “interface” refers to a generated display, such as one or more graphical user interfaces (GUIs) with which a user may interact, either directly or indirectly (e.g., through a keyboard, mouse, touchscreen, etc.).

“Authentication” is a process by which the credential of an endpoint (including but not limited to applications, people, devices, process, and systems) can be verified to ensure that the endpoint is who they are declared to be.

An “authorization request message,” or “transaction authorization request” may be an electronic message that is sent to a payment processing network and/or an issuer of a payment account to request authorization for a payment transaction. An authorization request message according to some embodiments or aspects may comply with International Organization for Standardization (ISO) 8583, which is a standard for systems that exchange electronic transaction information associated with a payment made by a consumer using a payment device or a payment account. An ISO 8583 message includes a message type indicator, one or more bitmaps indicating which data elements are present in the message, and data elements of the message. The authorization request message may include an issuer account identifier that may be associated with a payment device or payment account. An authorization request message may be generated by an acceptance device or a server and may be sent to an issuing financial institution directly or through a payment network. In some embodiments or aspects of the present disclosure, an authorization request message may include a payment token, an expiration date, a token presentment mode, a token requestor identifier, a token cryptogram, a token assurance level, and data used to generate the token assurance level. The payment token may include a payment token issuer identifier that may be a substitute for a real issuer identifier for an issuer. For example, the real issuer identifier may be part of a BIN range associated with the issuer. An authorization request message may also comprise additional data elements corresponding to “identification information” including, for example, a service code, a CVV or CVC (card verification value or code), a dCVV or dCVC (dynamic card verification value or code), token cryptogram, an expiration date, etc. An authorization request message may also comprise “transaction information,” such as any information associated with a current transaction (e.g. the transaction amount, merchant identifier, merchant location, etc.) as well as any other information that may be utilized in determining whether to identify and/or authorize a payment transaction.

An “authorization response message” may be an electronic message reply to an authorization request message generated by an issuing financial institution (e.g., issuer) or a payment processing network. The authorization response message may include, by way of example only, one or more of the following status indicators: Approval—transaction was approved; Decline—transaction was not approved; or Call Center—response pending more information, merchant must call the toll-free authorization phone number. The authorization response message may include an authorization code, which may be a code that an account issuing bank returns in response to an authorization request message in an electronic message (either directly or through the payment processing network) to the merchant's access device (e.g. POS terminal) that indicates approval of the transaction. The code may serve as proof of authorization. As noted above, in some embodiments or aspects, a payment processing network may generate and/or forward the authorization response message to the merchant.

As used herein, the term “communication” and “communicate” may refer to the reception, receipt, transmission, transfer, provision, and/or the like of information (e.g., data, signals, messages, instructions, calls, commands, and/or the like). A communication may use a direct or indirect connection and may be wired and/or wireless in nature. As an example, for one unit (e.g., a device, a system, a component of a device or system, combinations thereof, and/or the like) to communicate with another unit means that the one unit is able to directly or indirectly receive information from and/or transmit information to the other unit. The one unit may communicate with the other unit even though the information may be modified, processed, relayed, and/or routed between the one unit and the other unit. In one example, a first unit may communicate with a second unit even though the first unit receives information and does not communicate information to the second unit. For example, a first unit may be in communication with a second unit even though the first unit passively receives data and does not actively transmit data to the second unit. As another example, a first unit may communicate with a second unit if an intermediary unit (e.g., a third unit located between the first unit and the second unit) receives information from the first unit, processes the information received from the first unit to produce processed information, and communicates the processed information to the second unit. In some non-limiting embodiments or aspects, a message may refer to a packet (e.g., a data packet, a network packet, and/or the like) that includes data. It will be appreciated that numerous other arrangements are possible.

As used herein, the term “comprising” is not intended to be limiting, but may be a transitional term synonymous with “including,” “containing,” or “characterized by.” The term “comprising” may thereby be inclusive or open-ended and does not exclude additional, unrecited elements or method steps when used in a claim. For instance, in describing a method, “comprising” indicates that the claim is open-ended and allows for additional steps. In describing a device, “comprising” may mean that a named element(s) may be essential for an embodiment or aspect, but other elements may be added and still form a construct within the scope of a claim. In contrast, the transitional phrase “consisting of” excludes any element, step, or ingredient not specified in a claim. This is consistent with the use of the term throughout the specification.

As used herein, the term “computing device” or “computer device” may refer to one or more electronic devices that are configured to directly or indirectly communicate with or over one or more networks. A computing device may be a mobile device, a desktop computer, and/or the like. As an example, a mobile device may include a cellular phone (e.g., a smartphone or standard cellular phone), a portable computer, a wearable device (e.g., watches, glasses, lenses, clothing, and/or the like), a personal digital assistant (PDA), and/or other like devices. The computing device may not be a mobile device, such as a desktop computer. Furthermore, the term “computer” may refer to any computing device that includes the necessary components to send, receive, process, and/or output data, and normally includes a display device, a processor, a memory, an input device, a network interface, and/or the like.

A “condition” may be a value such as transaction amount, transaction type, the time of day at which settlement for a payment processing network occurs, merchant category code (MCC), merchant verification value (MVV), whether a payment processing network is subject to regulation, etc.

A “consumer” may include an individual or a user that may be associated with one or more personal accounts and/or consumer devices. The consumer may also be referred to as a cardholder, account holder, or user.

A “credential” may be any suitable information that serves as reliable evidence of worth, ownership, identity, or authority. A credential may be a string of numbers, letters, or any other suitable characters that may be present or contained in any object or document that can serve as confirmation. Examples of credentials include value credentials, identification cards, certified documents, access cards, passcodes and other login information, etc.

A “cryptographic algorithm” can be an encryption algorithm that transforms original data into an alternate representation, or a decryption algorithm that transforms encrypted information back to the original data. Examples of cryptographic algorithms may include triple data encryption standard (TDES), data encryption standard (DES), advanced encryption standard (AES), etc. Encryption techniques may include symmetric and asymmetric encryption techniques.

Reference to “a device,” “a server,” “a processor,” and/or the like, as used herein, may refer to a previously-recited device, server, or processor that is recited as performing a previous step or function, a different server or processor, and/or a combination of servers and/or processors. For example, as used in the specification and the claims, a first server or a first processor that is recited as performing a first step or a first function may refer to the same or different server or the same or different processor recited as performing a second step or a second function.

A “digital wallet” can include an electronic device that allows an individual to conduct electronic commerce transactions. A digital wallet may be designed to streamline the purchase and payment process. A digital wallet may allow the user to load one or more payment cards onto the digital wallet so as to make a payment without having to enter an account number or present a physical card.

A “digital wallet provider” may include an entity, such as an issuing bank or third party service provider, that issues a digital wallet to a user that enables the user to conduct financial transactions. A digital wallet provider may provide standalone user-facing software applications that store account numbers, or representations of the account numbers (e.g., payment tokens), on behalf of a cardholder (or other user) to facilitate payments at more than one unrelated merchant, perform person-to-person payments, or load financial value into the digital wallet. A digital wallet provider may enable a user to access its account via a personal computer, mobile device or access device. Additionally, a digital wallet provider may also provide one or more of the following functions: storing multiple payment cards and other payment products on behalf of a user, storing other information including billing address, shipping addresses, and transaction history, initiating a transaction by one or more methods, such as providing a user name and password, NFC or a physical token, and may facilitate pass-through or two-step transactions.

As used herein, an “electronic wallet,” “digital wallet” or “mobile wallet” can store user profile information, payment information (including tokens), bank account information, and/or the like and can be used in a variety of transactions, such as but not limited to eCommerce, social networks, money transfer/personal payments, mobile commerce, proximity payments, gaming, and/or the like for retail purchases, digital goods purchases, utility payments, purchasing games or gaming credits from gaming websites, transferring funds between users, and/or the like.

As used herein, the terms “electronic wallet,” “electronic wallet mobile application,” and “digital wallet” may refer to one or more electronic devices and/or one or more software applications configured to initiate and/or conduct transactions (e.g., payment transactions, electronic payment transactions, and/or the like). For example, an electronic wallet may include a user device (e.g., a mobile device) executing an application program and server-side software and/or databases for maintaining and providing transaction data to the user device.

As used herein, the term “electronic wallet provider” may include an entity that provides and/or maintains an electronic wallet and/or an electronic wallet mobile application for a user (e.g., a customer). Examples of an electronic wallet provider include, but are not limited to, Google Wallet™, Android Pay®, Apple Pay®, and Samsung Pay®, and/or other like electronic payment systems. In some non-limiting examples, a financial institution (e.g., an issuer institution) may be an electronic wallet provider. As used herein, the term “electronic wallet provider system” may refer to one or more computer systems, computer devices, servers, groups of servers, and/or the like operated by or on behalf of an electronic wallet provider.

An “end-user” or “user” may include any application, consumer, process, or system that is configured to interact with a requestor for tokenization/de-tokenization/token management services. For example, an end-user may include a consumer, a merchant, a mobile device, or any other suitable entity that may be associated with a requestor in the network token system.

An “interface” may include any software module configured to process communications. For example, an interface may be configured to receive, process, and respond to a particular entity in a particular communication format. Further, a computer, device, and/or system may include any number of interfaces depending on the functionality and capabilities of the computer, device, and/or system. In some embodiments or aspects, an interface may include an application programming interface (API) or other communication format or protocol that may be provided to third parties or to a particular entity to allow for communication with a device. Additionally, an interface may be designed based on functionality, a designated entity configured to communicate with, or any other variable. For example, an interface may be configured to allow for a system to field a particular request or may be configured to allow a particular entity to communicate with the system.

An “issuer” can include a payment account issuer. The payment account (which may be associated with one or more payment devices) may refer to any suitable payment account (e.g. credit card account, a checking account, a savings account, a merchant account assigned to a consumer, or a prepaid account), an employment account, an identification account, an enrollment account (e.g. a student account), etc.

The terms “issuer institution,” “portable financial device issuer,” “issuer,” or “issuer bank” may refer to one or more entities that provide one or more accounts (e.g., a credit account, a debit account, a credit card account, a debit card account, and/or the like) to a user (e.g., customer, consumer, and/or the like) for conducting transactions (e.g., payment transactions), such as initiating credit and/or debit payments. For example, an issuer may provide an account identifier, such as a personal account number (PAN), to a user that uniquely identifies one or more accounts associated with the user. The account identifier may be used by the user to conduct a payment transaction. The account identifier may be embodied on a portable financial device, such as a physical financial instrument, e.g., a payment card, and/or may be electronic and used for electronic payments. In some non-limiting embodiments or aspects, an issuer may be associated with a bank identification number (BIN) that uniquely identifies the issuer. As used herein “issuer system” or “issuer institution system” may refer to one or more systems operated by or operated on behalf of an issuer. For example, an issuer system may refer to a server executing one or more software applications associated with the issuer. In some non-limiting embodiments or aspects, an issuer system may include one or more servers (e.g., one or more authorization servers) for authorizing a payment transaction.

As used herein, the term “merchant” may refer to one or more individuals or entities (e.g., operators of retail businesses that provide goods and/or services, and/or access to goods and/or services, to a user (e.g., a customer, a consumer, a customer of the merchant, and/or the like) based on a transaction (e.g., a payment transaction)). As used herein “merchant system” may refer to one or more computer systems operated by or on behalf of a merchant, such as a server computer executing one or more software applications.

As used herein, a “mobile device” may comprise any electronic device that may be transported and operated by a user, which may also provide remote communication capabilities to a network. Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of mobile devices include mobile phones (e.g. cellular phones), PDAs, tablet computers, net books, laptop computers, personal music players, hand-held specialized readers, etc. Further examples of mobile devices include wearable devices, such as smart watches, fitness bands, ankle bracelets, rings, earrings, etc., as well as automobiles with remote communication capabilities. A mobile device may comprise any suitable hardware and software for performing such functions, and may also include multiple devices or components (e.g. when a device has remote access to a network by tethering to another device—e.g., using the other device as a modem—both devices taken together may be considered a single mobile device). A mobile device may also comprise a verification token in the form of, for instance, a secured hardware or software component within the mobile device and/or one or more external components that may be coupled to the mobile device. A detailed description of an exemplary mobile device is provided below.

As used herein, the term “multimedia object” may refer to a digital file containing multimedia content including audio, images, animations, video, vibration patterns, and interactive content. Multimedia objects may be represented in various formats and computer file types or may be represented by a pointer, network address, or uniform resource indicator (URI) denoting a location at which a multimedia file may be located and/or retrieved.

Multimedia objects may be output by a computing device with suitable output capability and may be observable by a device user or other entity.

A “payment application” or “wallet application” may store credentials (e.g., account identifier, expiration date, card verification value (CVV), etc.) for accounts provisioned onto the user device. The account credentials may be stored in general memory on the mobile device or on a secure trusted execution environment (e.g., a secure element) of the user device. Further, in some embodiments or aspects, the account credentials may be stored by a remote computer and the payment/wallet application may retrieve the credentials (or a portion thereof) from the remote computer before/during a transaction. Any number of different commands or communication protocols may be used to interface with the payment application and/or wallet application in order to obtain and use stored credentials associated with each application.

The payment application or wallet application may be configured to provide credentials to an authorized software application or module on a user device. For example, a payment application may be configured to interface with a master applet in order to provide credentials to a mobile application for a transaction. For instance, the payment application may provide a software development kit (SDK) or application programming interface (API) that the master wallet applet may use to interface with the payment application and/or wallet application. The payment application and/or wallet application may be configured to provide the sensitive information in encrypted form using stored encryption keys. Thus, each payment application and/or wallet application may have different commands and/or instructions for accessing the associated credentials stored by the payment/wallet application. For instance, each payment application and/or wallet application may have a different application program interface (API) with different commands, data requirements, authentication processes, etc., for interacting with other applications operating on the user device. Accordingly, a master wallet applet may include a number of different APIs, one for each of the different payment applications and/or wallet applications that the master wallet applet is configured to interface with.

A requestor may be referred to as a “token requestor” when requesting generation of a new token or requesting a new use of an existing token from a network token system. In some embodiments or aspects, a token requestor can request tokens for multiple domains and/or channels. Some non-limiting examples of token requestors may include, for example, card-on-file merchants, acquirers, acquirer processors, and payment gateways acting on behalf of merchants, payment enablers (e.g., original equipment manufacturers, mobile network operators, etc.), digital wallet providers, issuers, third party wallet providers, and/or payment processing networks. A token requestor may refer to an entity that is seeking to implement tokenization according to embodiments or aspects of the present disclosure. The token requestor may initiate a request that a primary account number (PAN) be tokenized by submitting a token request message to the token service provider.

According to various embodiments or aspects discussed herein, a token requestor may no longer need to store a PAN associated with a token once the requestor has received the token in response to a token request message. A token requestor may be registered and identified uniquely by the token service provider within the tokenization ecosystem. During token requestor registration, the token service provider may formally process token requestor's application to participate in the token service system. The token service provider may collect information pertaining to the nature of the requestor and relevant use of tokens to validate and formally approve the token requestor and establish appropriate domain restriction controls. Successfully registered token requestors may be assigned a token requestor identifier that may also be entered and maintained within the token vault. Token requestors be revoked or assigned new token requestor identifiers. This information may be subject to reporting and audit by the token service provider.

As used herein, the term “server” may include one or more computing devices which can be individual, stand-alone machines located at the same or different locations, may be owned or operated by the same or different entities, and may further be one or more clusters of distributed computers or “virtual” machines housed within a datacenter. It should be understood and appreciated by a person of skill in the art that functions performed by one “server” can be spread across multiple disparate computing devices for various reasons. As used herein, a “server” is intended to refer to all such scenarios and should not be construed or limited to one specific configuration. Further, a server as described herein may, but need not, reside at (or be operated by) a merchant, a payment network, a financial institution, a healthcare provider, a social media provider, a government agency, or agents of any of the aforementioned entities. The term “server” may also refer to or include one or more processors or computers, storage devices, or similar computer arrangements that are operated by or facilitate communication and processing for multiple parties in a network environment, such as the Internet, although it will be appreciated that communication may be facilitated over one or more public or private network environments and that various other arrangements are possible. Further, multiple computers, e.g., servers, or other computerized devices, e.g., point-of-sale devices, directly or indirectly communicating in the network environment may constitute a “system,” such as a merchant's point-of-sale system.

Reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

A “server computer” may typically be a powerful computer or cluster of computers. For example, the server computer can be a large mainframe, a minicomputer cluster, or a group of servers functioning as a unit. The server computer may be associated with an entity such as a payment processing network, a wallet provider, a merchant, an authentication cloud, an acquirer or an issuer. In one example, the server computer may be a database server coupled to a Web server. The server computer may be coupled to a database and may include any hardware, software, other logic, or combination of the preceding for servicing the requests from one or more client computers. The server computer may comprise one or more computational apparatuses and may use any of a variety of computing structures, arrangements, and compilations for servicing the requests from one or more client computers. In some embodiments or aspects, the server computer may provide and/or support payment network cloud service.

As used herein, “short range communication” or “short range wireless communication” may comprise any method of providing short-range contact or contactless communications capability, such as RFID, Bluetooth™, infra-red, or other data transfer capability that can be used to exchange data between a payment device and an access device. In some embodiments or aspects, short range communications may be in conformance with a standardized protocol or data transfer mechanism (e.g., ISO 14443/NFC). Short range communication typically comprises communications at a range of less than 2 meters. In some embodiments or aspects, it may be preferable to limit the range of short-range communications (e.g. to a range of less than 1 meter, less than 10 centimeters, or less than 2.54 centimeters) for security, technical, and/or practical considerations. For instance, it may not be desirable for a POS terminal to communicate with every payment device that is within a 2 meter radius because each of those payment devices may not be involved in a transaction, or such communication may interfere with a current transaction involving different financial transaction devices. Typically the payment device or the access device also includes a protocol for determining resolution of collisions (e.g., when two payment devices are communicating with the access device simultaneously). The use of short-range communications may be used when the merchant and the consumer are in close geographic proximity, such as when the consumer is at the merchant's place of business.

As used herein, the term “system” may refer to one or more computing devices or combinations of computing devices (e.g., processors, servers, client devices, software applications, components of such, and/or the like).

A “token” or “payment token” may include an identifier for a payment account that is a substitute for an account identifier, such as a primary account number (PAN). For example, a token may include a series of numeric and/or alphanumeric characters that may be used as a substitute for an original account identifier. For example, a token “4900 0000 0000 0001” may be used in place of a PAN “4147 0900 0000 1234.” In some embodiments or aspects, a token may be “format preserving” and may have a numeric format that conforms to the account identifiers used in existing payment processing networks (e.g., ISO 8583 financial transaction message format). In some embodiments or aspects, a token may be used in place of a PAN to initiate, authorize, settle or resolve a payment transaction or represent the original credential in other systems where the original credential would typically be provided. In some embodiments or aspects, a token value may be generated such that the recovery of the original PAN or other account identifier from the token value may not be computationally derived. For example, a token may have a random association with a particular real PAN so that the real PAN is not computationally derivable from the token. A lookup table may be used to associate a real PAN and a corresponding random token. Further, in some embodiments or aspects, the token format may be configured to allow the entity receiving the token to identify it as a token and recognize the entity that issued the token.

According to various embodiments or aspects, a token may be associated with a token status. The token status may indicate, for example, that the token is a high quality token or a low quality token. The status of the token may be indicative of a level of restriction associated with the token. For example, no restrictions may be imposed on a high quality token whereas restrictions such as further identification requirements may be imposed on a low quality token. The status of the token may be based at least in part on the confidence level with which the token is generated.

In some embodiments or aspects, tokens may be device-specific such that each device associated with an account may be provisioned with a particular token. As such, if a transaction uses a token that is initiated by a different device than the device that the token was provisioned into, the transaction may be fraudulent. Accordingly, device information may be stored in the token vault and used to ensure that the device used in a transaction is associated with the token that is being used in the transaction. Additionally, because each token may be associated with a single device, one PAN or account may have multiple tokens associated with it, where each PAN may have a different token for the different devices that may be used to initiate a transaction associated with the PAN using a specific token. This provides additional security for transactions because network token systems have additional information to validate in order to control the use of sensitive information in a transaction processing system. A number of tokens can include a number of dynamic tokens that can be requested for the same account identifier (e.g., PAN) and/or same device at one time. In some embodiments or aspects, the number of tokens can be optionally provided to the token requestor at the time of a token generation request. In some embodiments or aspects, tokens may be provided with overlapping time to live (TTL) so that one or more tokens may be active at any given time.

In some embodiments or aspects, the token format may allow entities in the payment system to identify the issuer associated with the token. For example, the format of the token may include a token issuer identifier that allows an entity (e.g. the payment processing network) to identify an issuer of the token. For instance, the token issuer identifier may be associated with an issuer's BIN of the underlying PAN in order to support the existing payment flow. The token issuer identifier may be a different number than the issuer's BIN and may be static. For example, if the issuer's BIN for an issuer is 412345, the token issuer identifier may be a token BIN of 428325 and this number may be static for all tokens issued from or for that issuer. In some embodiments or aspects, the token issuer identifier range (e.g., issuer token BIN range) may have the same attributes as the associated issuer card range and can be included in an issuer identifier routing table (e.g., BIN routing table). The issuer identifier routing table may be provided to the relevant entities in the payment system (e.g., merchants and acquirers).

“Tokenization” is a process by which data is replaced with substitute data. For example, a payment account identifier (e.g., a primary account number (PAN)) may be tokenized by replacing the primary account identifier with a substitute number (e.g. a token) that may be associated with the payment account identifier. Further, tokenization may be applied to any other-information which may be replaced with a substitute value (e.g., token, a credit card verification value (CVV)). Tokenization may be used to enhance transaction efficiency, improve transaction security, increase service transparency, or to provide a method for third-party enablement.

A “token assurance level” may refer to an indicator or a value that allows the token service provider to indicate the confidence level of the token to PAN binding. The token assurance level may be determined by the token service provider based on the type of identification and verification (ID&V) performed and the entity that performed the ID&V. The token assurance level may be set when issuing the token. The token assurance level may be updated if additional ID&V is performed.

“Token attributes” may include any feature or information about a token. For example, token attributes may include information that can determine how a token can be used, delivered, issued, or otherwise how data may be manipulated within a transaction system. For example, token attributes may determine how a token may be used in place of a real account identifier (e.g., PAN) for a transaction. For example, the token attributes may include a type of token, frequency of use, token expiry date and/or expiry time, a number of associated tokens, a transaction lifecycle expiry date, and any additional information that may be relevant to any entity within a tokenization ecosystem. For example, token attributes may include a wallet identifier associated with the token, an additional account alias or other user account identifier (e.g., an email address, username, etc.), a device identifier, an invoice number, etc. In some embodiments or aspects, a token requestor may provide token attributes at the time of requesting the generation of tokens. In some embodiments or aspects, a network token system, payment network associated with the network token system, an issuer, or any other entity associated with the token may determine and/or provide the token attributes associated with a particular token.

The token attributes may identify a type of token indicating how the token may be used. For example, a type of token may be “payment” or “non-payment” to identify the token as being a payment token or a non-payment token. A payment token may include a high value token that can be used in place of a real account identifier (e.g., PAN) to generate original and/or subsequent transactions for a consumer account and/or card.

Another token type may be a “static” or “dynamic” token type for static and dynamic tokens, respectively. For example, a static token may include a token that may be issued by a payment processing network or issuer that may be issued in place of an account identifier (e.g., PAN) and may be used for the duration of the underlying account identifier (e.g., PAN). As such, static tokens may be used to submit any number of transactions and may not change for each transaction. Static tokens may be securely stored on the consumer device (e.g., stored in a secure memory or secure element of a mobile device) or in the cloud by the token requestor and may be delivered securely to a mobile device. However, static tokens may include sensitive information that may be protected as they may be used to perform multiple transactions over long periods of time.

Alternatively, dynamic tokens can include tokens that are limited or restricted in use (e.g., limited by time, amount threshold (aggregated amount or single-transaction amount), or by number of uses). As such, dynamic tokens can be generated and delivered on a per-transaction or on an as needed basis to the end user to initiate a payment transaction through a registered and authenticated device and/or channel. For example, a one-time use dynamic token can be used at electronic-commerce (e-commerce) websites and if the dynamic token is intercepted by a third party, the dynamic token may be useless because it has been used and is thus worthless for future transactions.

Non-payment tokens may include tokens which are not substitutes for real account identifiers (e.g., PANs). For example, non-payment tokens may be used by merchant/acquirer systems for analytics, offers, customer support, marketing, etc. However, non-payment tokens may not be used to generate original and subsequent transactions using real account identifiers (e.g., PANs) or other account identifiers. Accordingly, non-payment tokens may include low value tokens that may be used for non-payment transactions or transaction services by an entity within the transaction processing system.

A “token request message” may be an electronic message for requesting a token. A token request message may include information usable for identifying a payment account or digital wallet, and/or information for generating a payment token. For example, a token request message may include payment credentials, mobile device identification information (e.g. a phone number or MSISDN), a digital wallet identifier, information identifying a tokenization service provider, a merchant identifier, a cryptogram, and/or any other suitable information. Information included in a token request message can be encrypted (e.g., with an issuer-specific key). In some embodiments or aspects, a token request message may be formatted as an authorization request message (e.g., an ISO 8583 message format). In some embodiments or aspects, the token request message may have a zero dollar amount in an authorization amount field. As another example, the token request message may include a flag or other indicator specifying that the message is a token request message.

A “token vault” may refer to a repository that maintains established token-to-PAN mappings. According to various embodiments or aspects, the token vault may also maintain other attributes of the token requestor that may be determined at the time of registration and that may be used by the token service provider to apply domain restrictions or other controls during transaction processing. For example, the token vault may maintain one-to-one mapping between a token and an account identifying number represented by the token. The token vault may be a part of the token service system. In some embodiments or aspects, the token vault may be provided as a part of the token service provider. Alternatively, the token vault may be a remote repository accessible by the token service provider. Token vaults, due to the sensitive nature of the data mappings that are stored and managed in them, may be protected by strong underlying physical and logical security.

As used herein, the term “transaction service provider” may refer to an entity that receives transaction authorization requests from merchants or other entities and provides guarantees of payment, in some cases through an agreement between the transaction service provider and an issuer. For example, a transaction service provider may include a payment network, such as Visa®, MasterCard®, American Express®, or any other entity that processes transactions. As used herein “transaction service provider system” may refer to one or more systems operated by or operated on behalf of a transaction service provider, such as a transaction service provider system executing one or more software applications associated with the transaction service provider. In some non-limiting embodiments or aspects, a transaction processing system may include one or more server computers with one or more processors and, in some non-limiting embodiments or aspects, may be operated by or on behalf of a transaction service provider.

A “user” may include an individual. In some embodiments or aspects, a user may be associated with one or more personal accounts and/or mobile devices. The user may also be referred to as a cardholder, account holder, or consumer.

A “user device” is an electronic device that may be transported and/or operated by a user. A user device may provide remote communication capabilities to a network. The user device may be configured to transmit and receive data or communications to and from other devices. In some embodiments or aspects, the user device may be portable. Examples of user devices may include mobile phones (e.g., smart phones, cellular phones, etc.), PDAs, portable media players, wearable electronic devices (e.g. smart watches, fitness bands, ankle bracelets, rings, earrings, etc.), electronic reader devices, and portable computing devices (e.g., laptops, netbooks, ultrabooks, etc.). Examples of user devices may also include automobiles with remote communication capabilities.

Before explaining various aspects of the devices, systems, and methods disclosed herein in detail, it should be noted that the illustrative examples are not limited in application or use to the details of construction and arrangement of system components illustrated in the accompanying drawings and description. The illustrative examples may be implemented or incorporated in other aspects, variations, and modifications, and may be practiced or carried out in various ways to achieve similar benefits. Further, unless otherwise indicated, the terms and expressions employed herein have been chosen for the purpose of describing the illustrative examples for the convenience of the reader and are not for the purpose of limitation thereof. Also, it will be appreciated that one or more of the following-described aspects, expressions of aspects, and/or examples, can be combined with any one or more of the other following-described aspects, expressions of aspects, and/or examples.

Cryptocurrencies are digital assets tracked via distributed ledgers that are hosted by various blockchain networks that use various proofs and methods of cryptography to secure the ledger and ensure its accuracy. Since the inception of Bitcoin, then general public's interest in trading cryptocurrencies has steadily increased and become a part of the cultural zeitgeist. Indeed, more and more institutional investors are pursuing cryptocurrencies, as are individuals seeking to profit from the growing number of applications presented by blockchain-based technologies. For example, presently, there are thousands of cryptocurrencies (e.g., Bitcoin, Ethereum, Cardano, Polygon, Polkadot, Internet Computer Protocol, Dogecoin, etc.) available for acquisition, trade, and/or use via hundreds of cryptocurrency exchanges (e.g., Binance, Coinbase, CEX.io, Kraken, Gemini, etc.).

In spite of the recent surge of interest in cryptocurrencies, en masse adoption has been relatively slow, especially regarding the use of cryptocurrencies for day-to-day transactions. Certainly, mainstream acceptance of cryptocurrencies has been hindered by a lack of products that provide easy access and use, which has led to a lack of understanding as to what cryptocurrencies are, a lack of trust in the stability of a cryptocurrency's value, regulatory uncertainty, and the fact that cryptocurrencies are not currently classified as legal tender. This may even be driven by the functional limitations of the blockchain itself. For example, most blockchain networks can process a mere fraction of the transaction volume typical of a conventional payment network. However, a lack of product focus has also inhibited the use and acceptance of cryptocurrencies for common, daily purchases. Many people may be aware of cryptocurrencies, but unable or uncomfortable using them every day. Conventional devices, systems, and methods—such as cryptocurrency wallets—lack intuitive tools to facilitate every day. Moreover, conventional devices, systems, and methods are incapable of integrating account information from other financial institutions to provide consumers with a true wallet capable of accessing a variety of financial assets for everyday transactions. Accordingly, there is a need for devices, systems, and methods for seamlessly integrating and facilitating the use of fiat and digital assets.

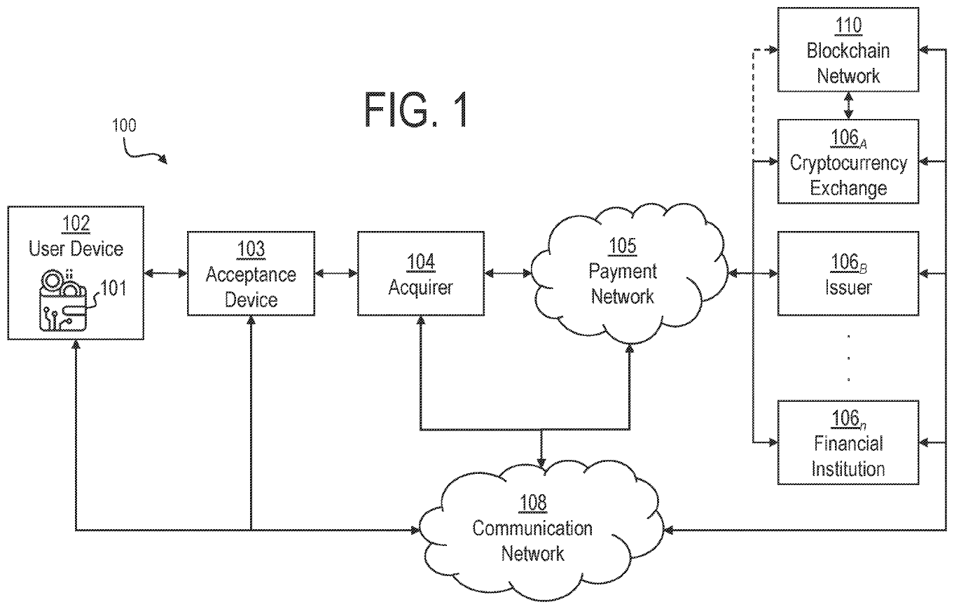

Referring now to FIG. 1, a system 100 for seamlessly integrating and facilitating the use of fiat and digital assets is depicted in accordance with at least one non-limiting aspect of the present disclosure. According to the non-limiting aspect of FIG. 1, the system 100 can include a user device 102, an acceptance device 103, an acquirer system 104, a payment network 105 and a plurality of financial institutions 106ₐ₋ₙ, one or more of which may be hosted on and/or include one or more servers operated by one or more entities, for example. However, it shall be appreciated that other possible configurations and arrangements of the components of the system 100 of FIG. 1 are contemplated by the present disclosure. Such configurations and arrangements may include fewer or more components, each of which may perform some or all of the tasks of the others, and may be owned or operated by various entities, including merchants, payment network providers, and financial institutions. As such, the system 100 of FIG. 1 is merely an illustrative example.

Also for illustrative purposes, communications between various components of the system 100 of FIG. 1 are shown as bi-directional, meaning information can be exchanged to and from each component. However, according to some aspects, one or more of the communications can be unidirectional.

According to the non-limiting aspect of FIG. 1, the system 100 can enable a user to communicate with a payment network 105 and/or cryptocurrency exchange 106_{A} using a user device 102. The user device 102 of FIG. 1 can include a mobile device, which may be a smartphone, portable computer, smart-watch or other wearable, and/or any other device configured to access account information (e.g., payment credentials, etc.) associated with an account hosted by one or more financial institution systems of the plurality of financial institution systems 106_{A-n}. Communications can be sent to and from various components of the system 100 via a communications network 108. According to the non-limiting aspect of FIG. 1, the communications network 108 can include the internet. However, according to other non-limiting aspects, the communications network can include any one or combinations of an infrastructure network (e.g., an intranet, an Ethernet, a local area network (LAN), a wireless local area network (WLAN), a cellular network, etc.) and/or an ad hoc network (e.g., Bluetooth®, Zigbee®, Near Field Communication (NFC), etc.). It shall be appreciated that any two components of the system 100 of FIG. 1—for example, the user device 102 and the acceptance device 103—can be configured to communicate with each other directly by establishing an ad hoc connection. However, this does not preclude any two of the components of the system 100—for example, the user device 102 and the payment network 105—from communicating with each other via an infrastructure network.

In further reference to FIG. 1, the payment network 105 can be configured to process transaction authorization requests pertaining to a purchase initiated by the user device 102 via the acceptance device 103 of a merchant, using an asset (e.g., fiat, a digital asset, loyalty rewards, etc.) associated with an account hosted by a financial institution system of the plurality of financial institution systems 106_{A-n}. For example, the plurality of financial institution systems 106_{A-n} can include a cryptocurrency exchange 106_{A} communicably coupled to a blockchain network 110. A second financial institution system of the plurality of financial institution systems 106_{A-n} can include an issuer system 106_{B}, such as a bank or credit union. In other words, any of the plurality of financial institution systems 106_{A-n} can be configured to host and/or have access to information associated with a financial account (e.g., a bank account, a credit card account, a checking account, a cryptocurrency exchange account, a loyalty rewards account, etc.) controlled by a user of the system 100 of FIG. 1. Moreover, each account hosted by the plurality of financial institution systems 106_{A-n} can be identified via a unique identifier associated with the account.

It shall be appreciated that, because the payment network 105 can be operated via a transaction service provider and configured to process transaction authorization requests on behalf of an acquirer system 104 and an issuer system 106_{B}, it is uniquely configured to communicate with the plurality of financial institution systems 106_{A-n} and perform the functions disclosed herein. Thus, as the user device 102 initiates the purchase, a transaction authorization request can be generated by the acceptance device 103 for the payment network 105 to forward to a financial institution system of the plurality of financial institution systems 106_{A-n}. Upon approval, the payment network 105 can coordinate a transfer of an asset (e.g., fiat, a digital asset, loyalty rewards, etc.).

Still referring to FIG. 1, the payment network 105 can implement an application programming interface (“API”) configured to facilitate communication with applications deployed by the various components of the system 100, such as the user device 102, the cryptocurrency exchange 106_{A}, any of the plurality of financial institution systems 106_{A-n}, and/or the blockchain network 110. The API, for example, can be stored in a memory of a server of the payment network 105 and, along with instructions also stored in the memory, can cause the one or more servers of the payment network 105 to perform the methods disclosed herein. For example, the user device 102 can access the API and initiate API calls including information and requests, which the payment network 105 can coordinate to resolution on behalf of the user device 102. Additionally, the payment network 105 can allow the API to be called by various third parties and/or third party entities and/or products (e.g., cryptocurrency wallet applications, exchange mobile applications, websites, digital wallets, banks, merchants, etc.), including the cryptocurrency exchange 106_{A}, to request the transmission of certain information and/or communications necessary to authenticate the user for access to digital assets (e.g., cryptocurrencies, non-fungible tokens (NFTs), governance tokens, stable coins, etc.).

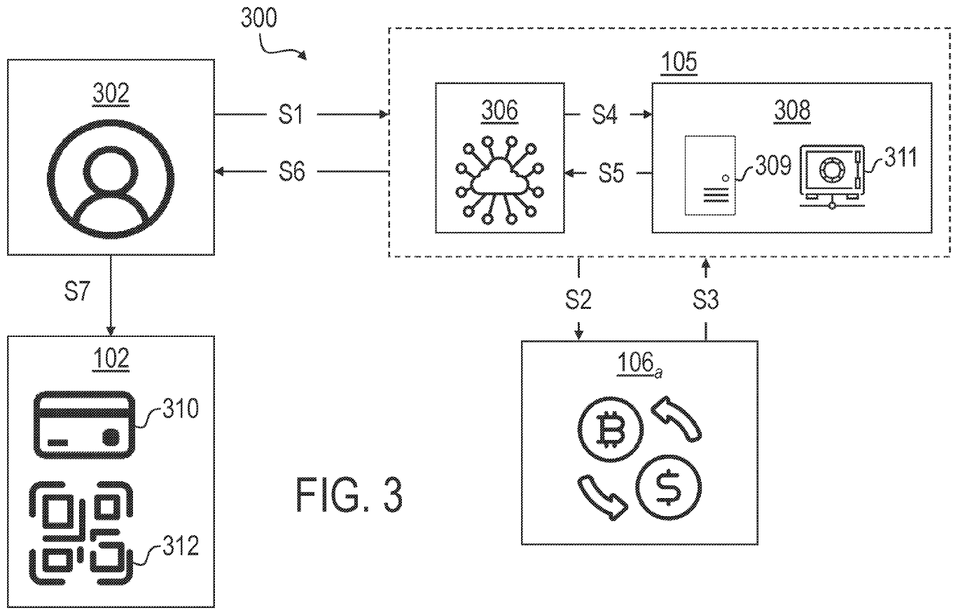

For example, according to the non-limiting aspect of FIG. 1, the user device 102 can be configured to execute and/or otherwise access a financial mobile application 101, through which the API can be accessed. According to some non-limiting aspects, the financial mobile application 101 can be a digital wallet. The wallet, for example, can be “non-custodial,” meaning the financial mobile application 101 does not provide the user with direct control of assets in accounts hosted by the plurality of financial institution systems 106_{A-n}. However, via the secure interface to the plurality of financial institution systems 106_{A-n} provided by the payment network 105—in conjunction with the tokenization system 308 (FIG. 3)—the user of the user device 102 will experience custodial-like experiences and functionality via the non-custodial financial mobile application 101. In other words, the system 100 can provide the user with more direct control and use of their digital and fiscal assets, as if they were being managed by a custodial wallet. However, it shall be appreciated that the term “wallet” is not intended to be limiting and that the system 100 and methods disclosed herein can be implemented via other means of software, websites, or platforms accessed by the user device 102 to achieve the same custodial-like experience for the user.

The user device 102 can be communicably coupled to the payment network 105 and configured to communicate with the payment network 105 via the API. Likewise, via the API, the financial mobile application 101 can be configured to receive, transmit, process, and/or present information received via the payment network 105, the plurality of financial institution systems 106_{A-n}, and/or the blockchain network 110 via a user interface displayed by the user device 102. According to some non-limiting aspects, the financial mobile application 101 can be stored on a memory of the user device 102. However, according to other non-limiting aspects, the financial mobile application 101 can be remotely stored relative to the user device 102 and accessed by the user device 102 via a website. Regardless, the user device 102 can be configured to access the financial mobile application 101 to access, display, and/or process account information associated with one or more accounts maintained by one or more of the plurality of financial institution systems 106_{A-n}.

As will be described in further detail with reference to FIG. 3, according to some non-limiting aspects, the payment network 105 of the system 100 of FIG. 1 can include a tokenization system 308 configured to tokenize and thus, securely protect account information on behalf of the plurality of the user device 102, the acceptance device 103, the acquirer system 104, and the plurality of financial institution systems 106_{A-n}. In other words, via the tokenization system 308 (FIG. 3), the payment network 105 can encode sensitive account information into tokens, or a special sequence of irreversible characters that improve protection against fraud and misuse and securely facilitate third-party transaction experiences. As such, tokens can be generated in association with various users of the system 100 and various accounts hosted by the plurality of financial institution systems 106_{A-n} and stored in a token vault 311 (FIG. 3) of the tokenization system 308 (FIG. 3). Tokenized information can be conveyed via the API and can be particularly configured to comply with security protocols of one or more of the plurality of financial institution systems 106_{A-n}. As such, it shall be appreciated that the payment network 105 can be specifically configured to facilitate secure communications between components of the system 100.

Accordingly, it shall be appreciated that the system 100 of FIG. 1 can be configured to access, process, display, and/or utilize account information from one or more of the plurality of financial institution systems 106_{A-n} via the financial mobile application 101 accessed by a user via the user device 102 without the need for a direct interaction between the user device 102 and the plurality of financial systems 106_{A-n}. The account information can include, for example, a balance of one or more assets (e.g., fiat, a digital asset, loyalty rewards, etc.) associated with an account hosted by one or more of the plurality of financial institution systems 106_{A-n}, a representation of an asset (e.g., an NFT, etc.) associated with an account hosted by one or more of the plurality of financial institution systems 106_{A-n}, and/or a machine-readable code associated with payment credentials of accounts hosted by one or more of the plurality of financial institution systems 106_{A-n}, amongst other information.

For example, in response to a user input provided via the user device 102, the system 100 of FIG. 1 can be configured to generate a machine-readable code associated with a payment credential of an account hosted by one or more of the plurality of financial institution systems 106_{A-n}. Accordingly, the machine-readable code (e.g., a quick response (QR) code, a bar code, a universal product code (UPC), a datamatrix code, an Aztec code, a PDF417 code, etc.) can be generated by the system 100, presented via a user interface of the financial mobile application 101, and registered via the acceptance device 103 of the merchant, which will initiate a transaction authorization request to be processed by the payment network 105. However, according to other non-limiting aspects, the machine-readable code can be non-visual and encoded in an audio file or an electromagnetic signal (e.g., transmitted via an infrastructure network, an ad hoc network, etc.), wherein the audio file and/or electromagnetic signal are configured to be registered by the acceptance device 103 of the merchant. For example, an electromagnetic signal can be transmitted via Bluetooth®, Zigbee®, radio frequency identification (RFID), and/or NFC, amongst other ad hoc networks.

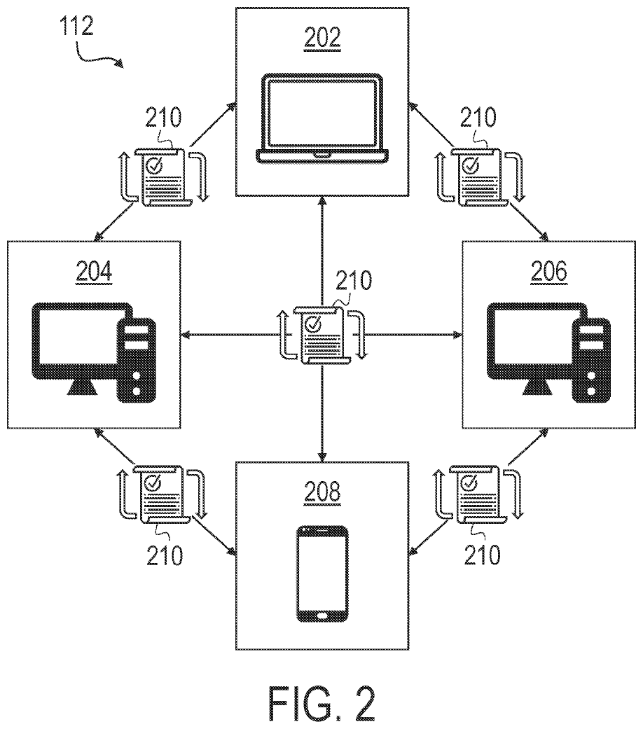

In further reference to FIG. 1, upon receiving the transaction authorization request—including the payment credentials embedded within the machine-readable code—the payment network 105 of the system 100 of FIG. 1 can be configured to process the transaction authorization request. The payment network 105 may confirm a condition of the transaction authorization request with a financial institution system 106_{A-n} that hosts the account associated with the payment credentials. For example, wherein the payment credentials are associated with a cryptocurrency account of the user, the payment network 105 may confirm that an account associated with the payment credentials and hosted by the cryptocurrency exchange 106_{A} has sufficient digital assets (e.g., cryptocurrencies, non-fungible tokens (NFTs), governance tokens, stable coins, etc.) to complete the transaction authorization request. The cryptocurrency exchange 106_{A} may confirm this by instructing the blockchain network 110 to consult a distributed ledger 210 (FIG. 2) hosted by the blockchain network 110. The cryptocurrency exchange 106_{A} can transmit the confirmation to the payment network 105, which can authorize the transaction and coordinate transfer of the required assets into a merchant account, such as an account hosted by the acquirer system 104.

Referring now to FIG. 2, a block diagram of a system for implementing a blockchain network 110 configured to interface with the cryptocurrency exchange 106_{A} (FIG. 1) of the system 100 of FIG. 1 and facilitate the acquisition and trading of digital assets is depicted, in accordance with at least one non-limiting aspect of the present disclosure.

According to the non-limiting aspect of FIG. 2, the blockchain network 110 can include one or more nodes 202, 204, 206, 208 configured to interact with each other such that the nodes 202, 204, 206, 208 can collectively host, modify, and verify a distributed ledger 210. For example, according to the non-limiting aspect of FIG. 2, the blockchain network 110 can include one or more laptop computers at node 202, personal computers at node 204, servers at node 206, and/or mobile computing devices at node 208, such as a smart phone and/or a tablet. However, it shall be appreciated that the non-limiting aspect of FIG. 2 is merely illustrative. As such, the blockchain network 110 can include any number and/or type of nodes 202, 204, 206, 208 necessary to effectively host, modify, and verify a distributed ledger 210. Moreover, certain privileges associated with the distributed ledger 210 can be selectively allocated to certain nodes 202, 204, 206, 208 of the blockchain network 110. For example, most nodes may be configured only to verify or validate the distributed ledger 210, while a select number of nodes may have the ability to modify the distributed ledger 210 and/or generate new blocks.

According to the non-limiting aspect of FIG. 2, the distributed ledger 210 can include records of transactions conducted between accounts associated with the blockchain network 110. For example, the distributed ledger 210 can include records associated with transactions executed via smart contracts, or code that automatically executes all components of an agreement that is then stored in the distributed ledger 210. The code itself can be replicated across the multiple nodes 202, 204, 206, 208 of a blockchain network 110 and, therefore, the system 100 (FIG. 1), the distributed ledger 210 and its records benefit from the security, permanence, and immutability provided by the blockchain network 110. Notably, the blockchain network 110 can include any foundational, “layer two,” or tributary chain, including chains such as the Bitcoin blockchain, Ethereum, Polygon, Arbitrum, and/or Loopring, amongst others.

In further reference to FIG. 2, a user operating a user device 102 (FIG. 1) can—via the financial mobile application 101 (FIG. 1) in communication with the payment network 105 (FIG. 1)—request account information from a cryptocurrency exchange 106_{A} (FIG. 1), which can include information associated with digital assets (e.g., cryptocurrencies, non-fungible tokens (NFTs), governance tokens, stable coins, etc.) associated with tokens tracked via the blockchain network 110 of FIG. 2. For example, digital assets can be transacted and monitored via the blockchain network 110 when one or more nodes 202, 204, 206, 208 generates a cryptographically signed message and transmit the message to blockchain network 110. The message can include transaction data such as information pertaining to an object of the transaction (e.g., cryptocurrencies, non-fungible tokens (NFTs), governance tokens, stable coins, etc.), a recipient, and/or an amount associated with the transaction, amongst other information. Once a node 202, 204, 206, 208 receives the message, the node 202, 204, 206, 208 can distribute the message to the other nodes 202, 204, 206, 208 in the blockchain network 110.

According to some non-limiting aspects, each of the nodes 202, 204, 206, 208 of the blockchain network 110 can include the transaction represented in the generated message in a block of other transactions and can attempt to validate or cryptographically solve the block. The first node 202, 204, 206, 208 that solves the block can provide the solution to the other validation nodes for verification, and ledger 210 maintained at each of the nodes 202, 204, 206, 208 can be updated to add the block to the distributed ledger 210 to effect the transaction. As an incentive to cryptographically solve blocks—which consumes electricity and computing resources—select nodes 202, 204, 206, 208 can earn at least a part of a token hosted on the distributed ledger 210 (e.g., cryptocurrencies, non-fungible tokens (NFTs), governance tokens, stable coins, etc.) and/or a fee for participating in the validation of the block. Alternately, the blockchain network 110 can require a node 202, 204, 206, 208 to stake at least a part of a token (e.g., cryptocurrencies, non-fungible tokens (NFTs), governance tokens, stable coins, etc.) hosted on the distributed ledger 210 until a transaction the node 202, 204, 206, 208 is trying the validate is confirmed.

As such, it shall be appreciated that the distributed ledger 210—and more generally, the blockchain network 110—of FIG. 2 can be used to track transactions and ownership of any number of digital assets, including cryptocurrencies and NFTs traded by one or more users via the cryptocurrency exchange 106_{A} (FIG. 1). In short, the blockchain network 110 can be configured to interface with the cryptocurrency exchange 106_{A} of FIG. 1, such that user device 102 (FIG. 1) can access, view, and utilize digital assets (e.g., cryptocurrencies, non-fungible tokens (NFTs), governance tokens, stable coins, etc.) otherwise managed and controlled by the blockchain network 110 via the cryptocurrency exchange 106_{A} (FIG. 1).

Moreover, because the payment network 105 (FIG. 1) can be specifically configured to interface with the cryptocurrency exchange 106_{A} (FIG. 1) via the API, the payment network 105—or any other component of system 100 (FIG. 1)—can be configured to generate a machine-readable code associated with account information (e.g., payment credentials, etc.) associated with accounts hosted by the cryptocurrency exchange 106_{A} (FIG. 1). The machine-readable code can be displayed via the user device 102 and, when registered by the acceptance device 103 of the merchant, can be used by the payment network 105 (FIG. 1) to process the transaction authorization request. Upon approval of the transaction authorization request via the cryptocurrency exchange 106_{A}, the payment network 105 can authorize the transaction. Accordingly, the cryptocurrency exchange 106_{A} can process a transaction to be validated by the nodes 202, 204, 206, 208 of the blockchain network 110 and recorded on the distributed ledger 210.

Referring now to FIG. 3, a block diagram of an architecture 300 configured to be implemented via the system 100 of FIG. 1 is depicted in accordance with at least one non-limiting aspect of the present disclosure. According to the non-limiting aspect of FIG. 3, a user 302 of the system 100 (FIG. 1) can purchase S1 a digital asset (e.g., cryptocurrencies, non-fungible tokens (NFTs), governance tokens, stable coins, etc.) by engaging a digital asset service application 306 hosted on the payment network 105. Although the user 302 can initiate the purchase via an application hosted on the user device 102, according to other non-limiting aspects, the user 302 can use a number of other computing devices communicably coupled to the payment network 105. In response to the purchase S1 request, the digital asset service application 306 can request S2 authentication of the request from the cryptocurrency exchange 106_{A}, which can provide S3 a response to the authentication request. Assuming the response is affirmative, response can include account information associated with the digital assets (e.g., cryptocurrencies, non-fungible tokens (NFTs), governance tokens, stable coins, etc.) acquired by the user 302.

Still referring to FIG. 3, the digital asset service application 306 can request S4 tokenization of account information received from the cryptocurrency exchange 106_{A} and, as previously discussed, a tokenization system 308 of the payment network 105 can include a tokenization engine 309 configured to encode sensitive account information into tokens and a token vault 311 configured to store generated tokens. As such, the tokenization system 308 can generate tokens associated with various users of the system 100 (FIG. 1) and various accounts hosted by the plurality of financial institution systems 106_{A-n} (FIG. 1) and store the generated tokens in a token vault 311 of the tokenization system 308. As such, the tokenization system 308 can transmit S5 a token corresponding to the requested account information back to the digital asset service application 306.

Tokenized information can be conveyed via the API and can be particularly configured to comply with security protocols of one or more of the plurality of financial institution systems 106_{A-n}. As such, it shall be appreciated that the payment network 105 can be specifically configured to facilitate secure communications between components of the system 100. The architecture of FIG. 3 facilitates a harmonization of the communication protocols associated with the different financial institution system 106_{A-n}. The user device 102 only need to communicate with the payment network 105 via the API, which then handles the interaction with the financial institution system 106_{A-n}.

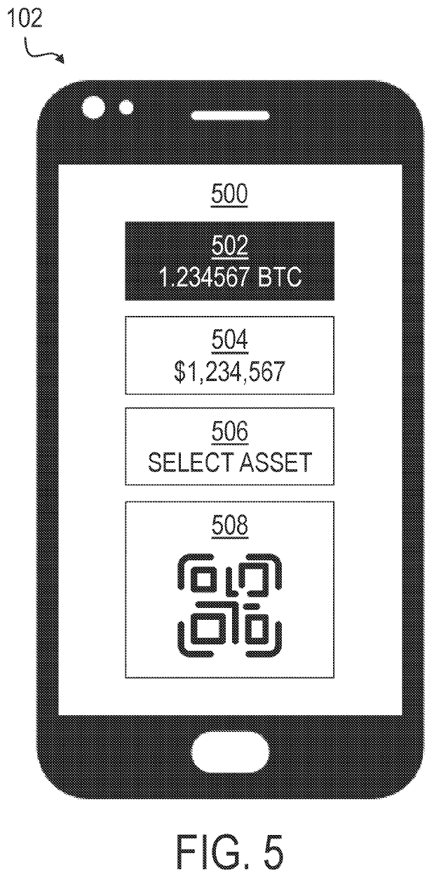

In the illustrated example, the digital asset service application 306 can transmit S6 a confirmation of the authenticated purchase and the token back to the user 302, who can load S7 the token for use onto the user device 102. It shall be appreciated that steps S1-S7 can be replicated for any of the plurality of financial institution systems 106_{A-n} (FIG. 1) of the system 100 (FIG. 1) and therefore, the payment network 105 can link account information and unique identifiers associated with any accounts hosted by the plurality of financial institution systems 106_{A-n} to the token. Thus, when the token is loaded S7 for use onto the user device 102, the user can access, view, and use account information associated with fiat and digital assets of multiple accounts hosted by the plurality of financial institution systems 106_{A-n}, all from a user interface 500 (FIG. 5) of the financial mobile application 101 (FIG. 1).

As depicted in FIG. 3, the user device 102—via a user interface of the financial mobile application 101 (FIG. 1)—can display a machine-readable code 312 associated with the token. However, as depicted in FIG. 3, the user interface of the financial mobile application 101 (FIG. 1) can be further configured to display account information, or tokenized account information, from any of the plurality of financial institution systems 106_{A-n}, such as a graphical representation 312 of a credit card issued by issuer system 106_{B}. For example, as will be described in further detail with reference to FIG. 5, the user interface 500 of the financial mobile application 101 (FIG. 1) can display account balances, transaction data, digital assets (such as NFTs), and/or widgets configured to enable a user of the user device 102 to access, view, and use fiat and digital assets from any of the plurality of financial institution systems 106_{A-n}.

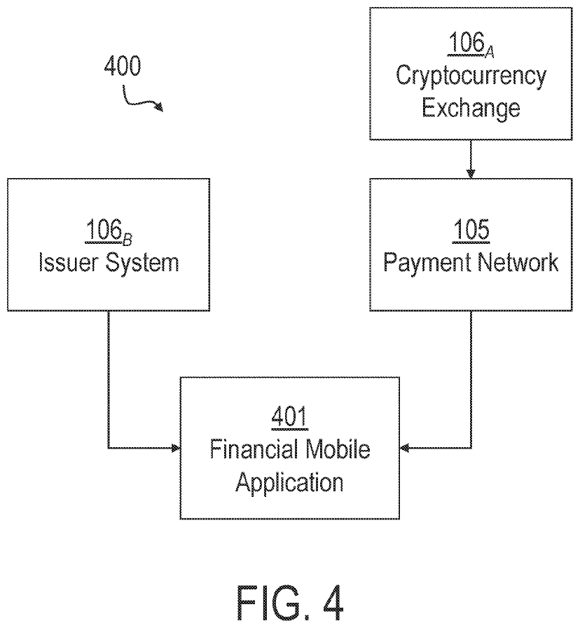

Referring now to FIG. 4, a block diagram of an alternate architecture 400 configured to be implemented via the system 100 of FIG. 1 is depicted in accordance with at least one non-limiting aspect of the present disclosure. The architecture 400 of FIG. 4 enables the system 100 to function substantially similarly to the architecture 300 of FIG. 3.

However, according to the non-limiting aspect of FIG. 4, the financial mobile application 401 is hosted and controlled by the issuer system 106_{B}. The financial mobile application 401 can be configured to integrate an API that enables the financial mobile application 401 to interface with the payment network 105, such that the interface with the cryptocurrency exchange 106_{A}, as depicted and described in reference to FIG. 3, can be leveraged on behalf of the financial mobile application 401 of the issuer system 106_{B}. For example, the API can enable the payment network 105 to facilitate access, display, and use of fiat and digital assets for the financial mobile application 401 of FIG. 5 in the same way as the payment network 105 facilitates the access, display, and use of fiat and digital assets via the financial mobile application 401 of FIG. 1.

Referring now to FIG. 5, a representative user interface 500 of the financial mobile applications 101, 401 of FIGS. 1 and 4 is depicted in accordance with at least one non-limiting aspect of the present disclosure. According to the non-limiting aspect of FIG. 5, the user interface 500 can be configured access, display, and facilitate use of fiat and digital assets associated with accounts hosted by the plurality of financial institution systems 106_{A-n} (FIG. 1). For example, a first widget 502 of the user interface 500 can display a digital asset (e.g., balance associated with an account hosted by one of the plurality of financial institution systems 106_{A-n} (FIG. 1), such as the cryptocurrency exchange 106_{A}. A second widget 504 of the user interface 500 can display a fiat balance associated with an account hosted by one of the plurality of financial institution systems 106_{A-n} (FIG. 1), such as an issuer system 106_{B}. Of course, according to other non-limiting aspects, the user interface 500 can include other widgets configured to display other information associated with accounts hosted by the plurality of financial institution systems 106_{A-n} (FIG. 1). For example, the user interface 500 can include widgets configured to display account balances, transaction data, and/or digital assets (such as NFTs) on the user device 102. According to still other non-limiting aspects, the user interface 500 can include a widget configured to instruct the cryptocurrency exchange 106_{A} (FIG. 1) to purchase digital assets on behalf of the user, via the payment network 105 (FIG. 1) and the tokenization system 308 (FIG. 3).

According to the non-limiting aspect of FIG. 5, the user interface 500 can further include a third widget 506 configured to enable a user to select either the digital assets displayed via the first widget 502 or the fiat assets displayed via the second widget 504 for use. For example, according to the non-limiting aspect of FIG. 5, the first widget has been selected for use and, upon interacting with the third widget 506, the user can cause the system 100 (FIG. 1) generate a machine-readable code 508. As previously discussed, the machine-readable code (e.g., a quick response (QR) code, a bar code, a universal product code (UPC), a datamatrix code, an Aztec code, a PDF417 code, audio file, electromagnetic signal, etc.) can be generated by the system 100 (FIG. 1), contain tokenized account information, and configured to be registered via the acceptance device 103 (FIG. 1) of the merchant. Upon registration via the acceptance device 103 (FIG. 1), the machine-readable code 508 can initiate a transaction authorization request to be processed by the payment network 105 using the selected assets from the selected account of the plurality of financial institution systems 106_{A-n} (FIG. 1). For example, according to the non-limiting aspect of FIG. 5, the first widget 502 displaying the digital asset is selected and thus, the machine-readable code 508 can include tokenized information associated with the account hosted by the cryptocurrency exchange 106_{A} for use via the transaction authorization request.

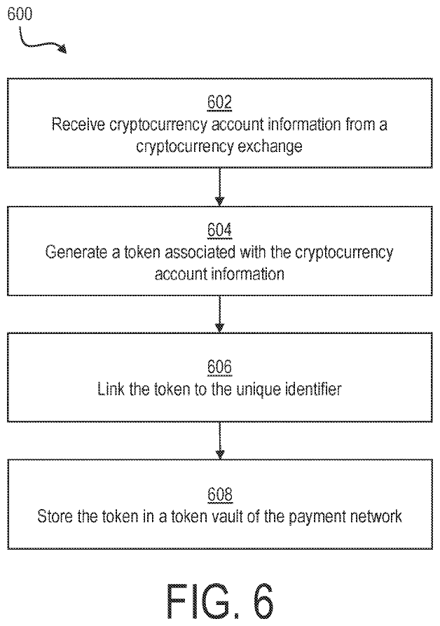

Referring now to FIG. 6, a logic flow diagram of another method 600 of seamlessly integrating and facilitating the use of fiat and digital assets is depicted in accordance with at least one non-limiting aspect of the present disclosure. It shall be appreciated that the method 600 can be performed by one or more components of the system 100 (FIG. 1) disclosed herein. For example, according to the non-limiting aspect of FIG. 6, the method 600 can be performed by a processor of a server of the payment network 105. However, according to other non-limiting aspects, one or more steps of the method 600 can be performed by any other components of the system 100 (FIG. 1). According to the non-limiting aspect of FIG. 6, the method 600 can include receiving 602 cryptocurrency account information from a cryptocurrency exchange 106_{A} of a plurality of financial institution systems 106_{A-n}. The cryptocurrency account information can include information pertaining to a digital asset (e.g., cryptocurrencies, non-fungible tokens (NFTs), governance tokens, stable coins, etc.) owned by the user and stored on the blockchain network 110 (FIG. 1) in communication with the cryptocurrency exchange 106_{A} (FIG. 1). Upon receiving the cryptocurrency account information, the method 600 can include generating 604 a token associated with the cryptocurrency account information. As previously discussed, tokenization can be performed by a tokenization system 308 (FIG. 3) of the payment network 105.

In further reference to FIG. 6, the method 600 can further include receiving 606 a unique identifier from an issuer system 106_{B} of the plurality of financial institution systems 106_{A-n}. As previously explained, each account hosted by the plurality of financial institution systems 106_{A-n} can be identified via a unique identifier. The unique identifier, for example, can include information pertaining to a fiat-based asset (e.g., cryptocurrencies, non-fungible tokens (NFTs), governance tokens, stable coins, etc.) owned by the user and tracked via an account hosted by the issuer system 106_{B} (FIG. 1). Upon receiving the unique identifier, the method 600 can include linking 608 the previously generated token to the unique identifier and storing 610 the token in a token vault 311 (FIG. 3) of the tokenization system 308 (FIG. 3) of the payment network 105 (FIG. 1).

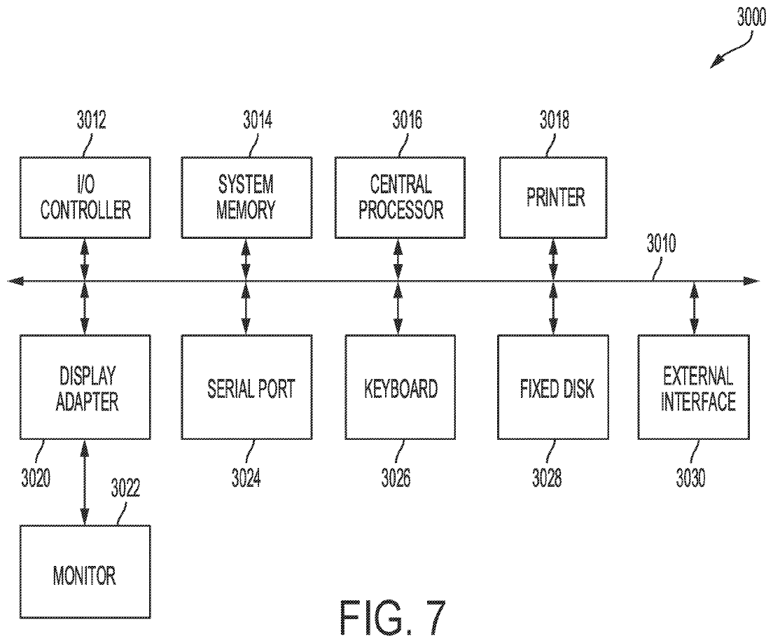

FIG. 7 is a block diagram of a computer apparatus 3000 with data processing subsystems or components, according to at least one aspect of the present disclosure. The subsystems shown in FIG. 6 are interconnected via a system bus 3010. Additional subsystems such as a printer 3018, keyboard 3026, fixed disk 3028 (or other memory comprising computer readable media), monitor 3022, which is coupled to a display adapter 3020, and others are shown. Peripherals and input/output (I/O) devices, which couple to an I/O controller 3012 (which can be a processor or other suitable controller), can be connected to the computer system by any number of means known in the art, such as a serial port 3024. For example, the serial port 3024 or external interface 3030 can be used to connect the computer apparatus to a wide area network such as the Internet, a mouse input device, or a scanner. The interconnection via system bus allows the central processor 3016 to communicate with each subsystem and to control the execution of instructions from system memory 3014 or the fixed disk 3028, as well as the exchange of information between subsystems. The system memory 3014 and/or the fixed disk 3028 may embody a computer readable medium.

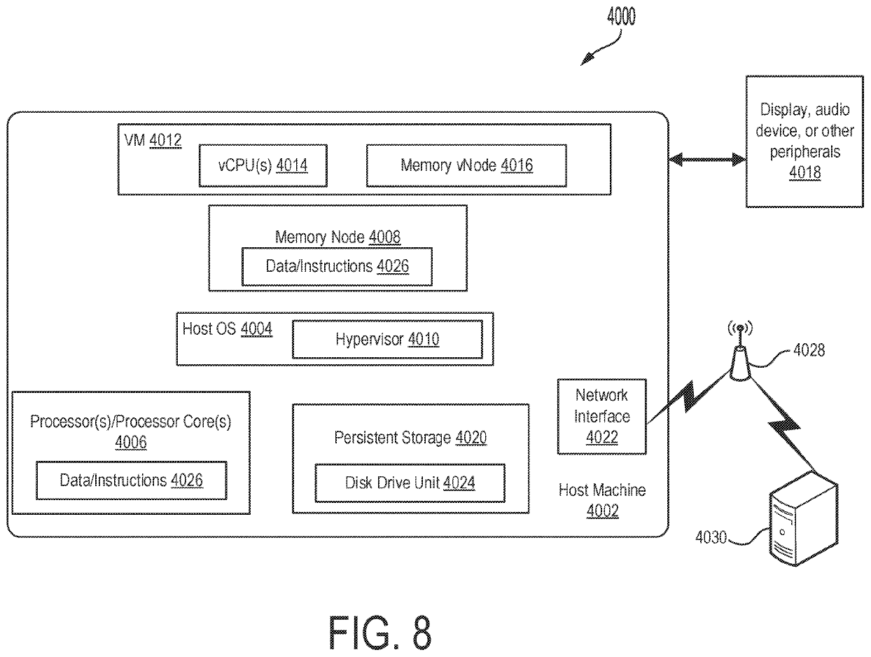

FIG. 8 is a diagrammatic representation of an example system 4000 that includes a host machine 4002 within which a set of instructions to perform any one or more of the methodologies discussed herein may be executed, according to at least one aspect of the present disclosure. In various aspects, the host machine 4002 operates as a standalone device or may be connected (e.g., networked) to other machines. In a networked deployment, the host machine 4002 may operate in the capacity of a server or a client machine in a server-client network environment, or as a peer machine in a peer-to-peer (or distributed) network environment. The host machine 3002 may be a computer or computing device, a personal computer (PC), a tablet PC, a set-top box (STB), a personal digital assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example system 4000 includes the host machine 4002, running a host operating system (OS) 4004 on a processor or multiple processor(s)/processor core(s) 4006 (e.g., a central processing unit (CPU), a graphics processing unit (GPU), or both), and various memory nodes 4008. The host OS 4004 may include a hypervisor 4010 which is able to control the functions and/or communicate with a virtual machine (VM) 4012 running on machine readable media. The VM 4012 also may include a virtual CPU or vCPU 4014. The memory nodes 4008 may be linked or pinned to virtual memory nodes or vNodes 4016. When the memory node 4008 is linked or pinned to a corresponding vNode 4016, then data may be mapped directly from the memory nodes 4008 to their corresponding vNodes 4016.

All the various components shown in host machine 4002 may be connected with and to each other, or communicate to each other via a bus (not shown) or via other coupling or communication channels or mechanisms. The host machine 4002 may further include a video display, audio device or other peripherals 4018 (e.g., a liquid crystal display (LCD), alpha-numeric input device(s) including, e.g., a keyboard, a cursor control device, e.g., a mouse, a voice recognition or biometric verification unit, an external drive, a signal generation device, e.g., a speaker,) a persistent storage device 4020 (also referred to as disk drive unit), and a network interface device 4022. The host machine 4002 may further include a data encryption module (not shown) to encrypt data. The components provided in the host machine 4002 are those typically found in computer systems that may be suitable for use with aspects of the present disclosure and are intended to represent a broad category of such computer components that are known in the art. Thus, the system 4000 can be a server, minicomputer, mainframe computer, or any other computer system. The computer may also include different bus configurations, networked platforms, multi-processor platforms, and the like. Various operating systems may be used including UNIX, LINUX, WINDOWS, QNX ANDROID, IOS, CHROME, TIZEN, and other suitable operating systems.

The disk drive unit 4024 also may be a Solid-state Drive (SSD), a hard disk drive (HDD) or other includes a computer or machine-readable medium on which is stored one or more sets of instructions and data structures (e.g., data/instructions 4026) embodying or utilizing any one or more of the methodologies or functions described herein. The data/instructions 4026 also may reside, completely or at least partially, within the main memory node 4008 and/or within the processor(s) 4006 during execution thereof by the host machine 4002. The data/instructions 4026 may further be transmitted or received over a network 4028 via the network interface device 4022 utilizing any one of several well-known transfer protocols (e.g., Hyper Text Transfer Protocol (HTTP)).

The processor(s) 4006 and memory nodes 4008 also may comprise machine-readable media. The term “computer-readable medium” or “machine-readable medium” should be taken to include a single medium or multiple medium (e.g., a centralized or distributed database and/or associated caches and servers) that store the one or more sets of instructions. The term “computer-readable medium” shall also be taken to include any medium that is capable of storing, encoding, or carrying a set of instructions for execution by the host machine 4002 and that causes the host machine 4002 to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example aspects described herein may be implemented in an operating environment comprising software installed on a computer, in hardware, or in a combination of software and hardware.

One skilled in the art will recognize that Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized to implement any of the various aspects of the disclosure as described herein.

The computer program instructions also may be loaded onto a computer, a server, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Suitable networks may include or interface with any one or more of, for instance, a local intranet, a PAN (Personal Area Network), a LAN (Local Area Network), a WAN (Wide Area Network), a MAN (Metropolitan Area Network), a virtual private network (VPN), a storage area network (SAN), a frame relay connection, an Advanced Intelligent Network (AIN) connection, a synchronous optical network (SONET) connection, a digital T1, T3, E1 or E3 line, Digital Data Service (DDS) connection, DSL (Digital Subscriber Line) connection, an Ethernet connection, an ISDN (Integrated Services Digital Network) line, a dial-up port such as a V.90, V.34 or V.34bis analog modem connection, a cable modem, an ATM (Asynchronous Transfer Mode) connection, or an FDDI (Fiber Distributed Data Interface) or CDDI (Copper Distributed Data Interface) connection. Furthermore, communications may also include links to any of a variety of wireless networks, including WAP (Wireless Application Protocol), GPRS (General Packet Radio Service), GSM (Global System for Mobile Communication), CDMA (Code Division Multiple Access) or TDMA (Time Division Multiple Access), cellular phone networks, GPS (Global Positioning System), CDPD (cellular digital packet data), RIM (Research in Motion, Limited) duplex paging network, Bluetooth radio, or an IEEE 802.11-based radio frequency network. The network 4030 can further include or interface with any one or more of an RS-232 serial connection, an IEEE-1394 (Firewire) connection, a Fiber Channel connection, an IrDA (infrared) port, a SCSI (Small Computer Systems Interface) connection, a USB (Universal Serial Bus) connection or other wired or wireless, digital or analog interface or connection, mesh or Digi® networking.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud is formed, for example, by a network of web servers that comprise a plurality of computing devices, such as the host machine 4002, with each server 4030 (or at least a plurality thereof) providing processor and/or storage resources. These servers manage workloads provided by multiple users (e.g., cloud resource customers or other users). Typically, each user places workload demands upon the cloud that vary in real-time, sometimes dramatically. The nature and extent of these variations typically depends on the type of business associated with the user.

It is noteworthy that any hardware platform suitable for performing the processing described herein is suitable for use with the technology. The terms “computer-readable storage medium” and “computer-readable storage media” as used herein refer to any medium or media that participate in providing instructions to a CPU for execution. Such media can take many forms, including, but not limited to, non-volatile media, volatile media, and transmission media. Non-volatile media include, for example, optical or magnetic disks, such as a fixed disk. Volatile media include dynamic memory, such as system RAM. Transmission media include coaxial cables, copper wire and fiber optics, among others, including the wires that comprise one aspect of a bus. Transmission media can also take the form of acoustic or light waves, such as those generated during radio frequency (RF) and infrared (IR) data communications. Common forms of computer-readable media include, for example, a flexible disk, a hard disk, magnetic tape, any other magnetic medium, a CD-ROM disk, digital video disk (DVD), any other optical medium, any other physical medium with patterns of marks or holes, a RAM, a PROM, an EPROM, an EEPROM, a FLASH EPROM, any other memory chip or data exchange adapter, a carrier wave, or any other medium from which a computer can read.

Various forms of computer-readable media may be involved in carrying one or more sequences of one or more instructions to a CPU for execution. A bus carries the data to system RAM, from which a CPU retrieves and executes the instructions. The instructions received by system RAM can optionally be stored on a fixed disk either before or after execution by a CPU.

Computer program code for carrying out operations for aspects of the present technology may be written in any combination of one or more programming languages, including an object oriented programming language such as Java, Smalltalk, C++, or the like and conventional procedural programming languages, such as the “C” programming language, Go, Python, or other programming languages, including assembly languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Examples of the method according to various aspects of the present disclosure are provided below in the following numbered clauses. An aspect of the method may include any one or more than one, and any combination of, the numbered clauses described below.
Clause 1. A computer-implemented method, including receiving, by a payment network, cryptocurrency account information associated with a digital asset account hosted by a cryptocurrency exchange, generating, by the payment network, a token associated with the cryptocurrency account information, receiving, by the payment network, a unique identifier from an issuer system, wherein the unique identifier is associated with a fiat-based asset account hosted by the issuer system, linking, by the payment network, the token to the unique identifier; and storing, by the payment network, the token in a token vault of the payment network.
Clause 2. The computer-implemented method according to clause 1, further including receiving, by the payment network, a token request from a user device, identifying, by the payment network, the token stored in the token vault based on the token request, transmitting, by an API of the payment network, the token from the token vault to the user device in response to the token request.
Clause 3. The computer-implemented method according to either of clauses 1 or 2, further including causing, by the API of the payment network, the user device to display the cryptocurrency account information based on the token, wherein the cryptocurrency account information is displayed via a wallet application accessed via the user device, and causing, by the API of the payment network, the user device to display fiat-based account information based on the token, wherein the fiat-based account information is associated with the unique identifier, and wherein the fiat-based account information is displayed via the wallet application accessed via the user device.
Clause 4. The computer-implemented method according to any of clauses 1-3, further including receiving, by the payment network, a user input from the user device, generating, by the payment network, a machine-readable code associated with the token based on the user input, wherein the machine-readable code is configured to initiate a transaction authorization request when registered by an acceptance device, and transmitting, by the payment network, the machine-readable code to the user device.
Clause 5. The computer-implemented method according to any of clauses 1-4, further including receiving, by the payment network, the transaction authorization request in response to the acceptance device registering the machine-readable code, verifying, by the payment network, the machine-readable code, and completing, by the payment network, the transaction authorization request based on the verification of the machine-readable code.
Clause 6. The computer-implemented method according to any of clauses 1-5, wherein the user input includes a selection of the cryptocurrency account information, and wherein completion of the transaction authorization request based on the verification of the machine-readable code includes causing the cryptocurrency exchange to debit the digital asset account based on the verification of the machine-readable code.
Clause 7. The computer-implemented method according to any of clauses 1-6, wherein the user input includes a selection of the fiat-based account information, and wherein completion of the transaction request based on the verification of the machine-readable code includes causing the issuer system to debit the fiat-based asset account based on the verification of the machine-readable code.
Clause 8. The computer-implemented method according to any of clauses 1-7 further including receiving, by the payment network, a purchase request for a digital asset, verifying, by the payment network, that the token is linked to the unique identifier, and initiating, by the payment network, fulfillment of the purchase request via the cryptocurrency exchange based on the verification that the token is linked to the unique identifier.
Clause 9. A payment network communicably coupled to a plurality of financial institution systems, wherein the plurality of financial institution systems includes a cryptocurrency exchange configured to host a digital asset account, and an issuer system configured to host a fiat-based asset account, the payment network including a tokenization engine configured to receive cryptocurrency account information associated with the digital asset account from the cryptocurrency exchange, generate a token associated with the cryptocurrency account information, receive a unique identifier associated with the fiat-based asset account hosted by the issuer system, link the token to the unique identifier, and a token vault configured to receive the token from the tokenization engine, and store the token.
Clause 10. The payment according to clause 9, wherein the payment network is communicably coupled to a user device via an application program interface (API) integrated into a financial mobile application accessed by the user device, and wherein the tokenization engine is further configured to receive a token request from the user device via the API, identify the token stored in the token vault based on the token request, and transmit the token from the token vault to the user device via the API, in response to the token request.
Clause 11. The payment network according to either of clauses 9 or 10, wherein the payment network is configured to receive a user input from the user device via the API, generate a machine-readable code associated with the token based on the user input, wherein the machine-readable code is configured to initiate a transaction authorization request when registered by an acceptance device, and transmit the machine-readable code to the user device via the API.
Clause 12. The payment network according to any of clauses 9-11, wherein the payment network is configured to receive the transaction authorization request in response to the acceptance device registering the machine-readable code, verify the machine-readable code, and complete the transaction authorization request based on the verification of the machine-readable code.
Clause 13. The payment network according to any of clauses 9-12, wherein the user input includes a selection of the cryptocurrency account information, and wherein completion of the transaction authorization request based on the verification of the machine-readable code includes causing the cryptocurrency exchange to debit the digital asset account based on the verification of the machine-readable code.
Clause 14. The payment network according to any of clauses 9-13, wherein the user input includes a selection of fiat-based account information associated with the unique identifier, and wherein completion of the transaction authorization request based on the verification of the machine-readable code includes causing the issuer system to debit the fiat-based asset account based on the verification of the machine-readable code.
Clause 15. The payment network according to any of clauses 9-14, wherein the payment network is configured to receive a purchase request for a digital asset from the user device via the API, verify that the token is linked to the unique identifier, and initiate fulfillment of the purchase request via the cryptocurrency exchange based on the verification that the token is linked to the unique identifier.
Clause 16. A system, including a payment network communicably coupled to a plurality of financial institution systems, wherein the plurality of financial institution systems includes a cryptocurrency exchange configured to host a digital asset account, and an issuer system configured to host a fiat-based asset account, wherein the payment network is configured to receive cryptocurrency account information associated with the digital asset account from the cryptocurrency exchange, generate a token associated with the cryptocurrency account information, receive a unique identifier associated with the fiat-based asset account hosted by the issuer system, link the token to the unique identifier, and store the token, and a financial mobile application, installable on a user device including a processor and a memory, the financial mobile application including an application program interface (API) communicably couplable to the payment network, wherein the API is configured to cause the user device to receive the token from the payment network, display the cryptocurrency account information based on the token, and display fiat-based account information based on the token, wherein the account information is associated with the unique identifier.
Clause 17. The system according to clause 16, wherein the financial mobile application includes a user interface, and wherein the API is configured to cause the user device to receive a user input via the user interface of the financial mobile application, wherein the user input includes a selection of the cryptocurrency account information, and transmit the user input to the payment network via the API.
Clause 18. The system according to either of clauses 16 or 17, wherein the payment network is configured to receive the user input from the user device via the API, generate a machine-readable code associated with the token based on the user input, wherein the machine-readable code is configured to initiate a transaction authorization request when registered by an acceptance device, and transmit the machine-readable code to the user device.
Clause 19. The system according to any of clauses 16-18, wherein the payment network is configured to receive the transaction authorization request in response to the acceptance device registering the machine-readable code, verify the machine-readable code, and complete the transaction authorization request based on the verification of the machine-readable code, wherein completion of the transaction authorization request includes causing the cryptocurrency exchange to debit the digital asset account based on the verification of the machine-readable code.
Clause 20. The system according to any of clauses 16-19, wherein the payment network is configured to receive a purchase request for a digital asset from the user device via the API, verify that the token is linked to the unique identifier, and initiate fulfillment of the purchase request via the cryptocurrency exchange based on the verification that the token is linked to the unique identifier.

The foregoing detailed description has set forth various forms of the systems and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, and/or examples can be implemented, individually and/or collectively, by a wide range of hardware, software, firmware, or virtually any combination thereof. Those skilled in the art will recognize that some aspects of the forms disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as one or more program products in a variety of forms, and that an illustrative form of the subject matter described herein applies regardless of the particular type of signal bearing medium used to actually carry out the distribution.

Instructions used to program logic to perform various disclosed aspects can be stored within a memory in the system, such as dynamic random access memory (DRAM), cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, compact disc, read-only memory (CD-ROMs), and magneto-optical disks, read-only memory (ROMs), random access memory (RAM), erasable programmable read-only memory (EPROM), electrically erasable programmable read-only memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the non-transitory computer-readable medium includes any type of tangible machine-readable medium suitable for storing or transmitting electronic instructions or information in a form readable by a machine (e.g., a computer).

Any of the software components or functions described in this application, may be implemented as software code to be executed by a processor using any suitable computer language such as, for example, Python, Java, C++ or Perl using, for example, conventional or object-oriented techniques. The software code may be stored as a series of instructions, or commands on a computer readable medium, such as RAM, ROM, a magnetic medium such as a hard-drive or a floppy disk, or an optical medium such as a CD-ROM. Any such computer readable medium may reside on or within a single computational apparatus, and may be present on or within different computational apparatuses within a system or network.

As used in any aspect herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

As used in any aspect herein, the terms “component,” “system,” “module” and the like can refer to a computer-related entity, either hardware, a combination of hardware and software, software, or software in execution.

As used in any aspect herein, an “algorithm” refers to a self-consistent sequence of steps leading to a desired result, where a “step” refers to a manipulation of physical quantities and/or logic states which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities and/or states.

A network may include a packet switched network. The communication devices may be capable of communicating with each other using a selected packet switched network communications protocol. One example communications protocol may include an Ethernet communications protocol which may be capable of permitting communication using a Transmission Control Protocol/Internet Protocol (TCP/IP). The Ethernet protocol may comply or be compatible with the Ethernet standard published by the Institute of Electrical and Electronics Engineers (IEEE) titled “IEEE 802.3 Standard”, published in December, 2008 and/or later versions of this standard. Alternatively or additionally, the communication devices may be capable of communicating with each other using an X.25 communications protocol. The X.25 communications protocol may comply or be compatible with a standard promulgated by the International Telecommunication Union-Telecommunication Standardization Sector (ITU-T). Alternatively or additionally, the communication devices may be capable of communicating with each other using a frame relay communications protocol. The frame relay communications protocol may comply or be compatible with a standard promulgated by Consultative Committee for International Telegraph and Telephone (CCITT) and/or the American National Standards Institute (ANSI). Alternatively or additionally, the transceivers may be capable of communicating with each other using an Asynchronous Transfer Mode (ATM) communications protocol. The ATM communications protocol may comply or be compatible with an ATM standard published by the ATM Forum titled “ATM-MPLS Network Interworking 2.0” published August 2001, and/or later versions of this standard. Of course, different and/or after-developed connection-oriented network communication protocols are equally contemplated herein.

Unless specifically stated otherwise as apparent from the foregoing disclosure, it is appreciated that, throughout the present disclosure, discussions using terms such as “processing,” “computing,” “calculating,” “determining,” “displaying,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

One or more components may be referred to herein as “configured to,” “configurable to,” “operable/operative to,” “adapted/adaptable,” “able to,” “conformable/conformed to,” etc. Those skilled in the art will recognize that “configured to” can generally encompass active-state components and/or inactive-state components and/or standby-state components, unless context requires otherwise.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

As used herein, the singular form of “a”, “an”, and “the” include the plural references unless the context clearly dictates otherwise.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material. None is admitted to be prior art.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A computer-implemented method, comprising:
receiving, by a payment network, cryptocurrency account information associated with a digital asset account hosted by a cryptocurrency exchange;
generating, by the payment network, a token associated with the cryptocurrency account information;
receiving, by the payment network, a unique identifier from an issuer system, wherein the unique identifier is associated with a fiat-based asset account hosted by the issuer system;
linking, by the payment network, the token to the unique identifier; and
storing, by the payment network, the token in a token vault of the payment network.

2. The computer-implemented method of claim 1, further comprising:
receiving, by the payment network, a token request from a user device;
identifying, by the payment network, the token stored in the token vault based on the token request; and
transmitting, by an API of the payment network, the token from the token vault to the user device in response to the token request.

3. The computer-implemented method of claim 2, further comprising:
causing, by the API of the payment network, the user device to display the cryptocurrency account information based on the token, wherein the cryptocurrency account information is displayed via a wallet application accessed via the user device; and
causing, by the API of the payment network, the user device to display fiat-based account information based on the token, wherein the fiat-based account information is associated with the unique identifier, and wherein the fiat-based account information is displayed via the wallet application accessed via the user device.

4. The computer-implemented method of claim 3, further comprising:
receiving, by the payment network, a user input from the user device;
generating, by the payment network, a machine-readable code associated with the token based on the user input, wherein the machine-readable code is configured to initiate a transaction authorization request when registered by an acceptance device; and
transmitting, by the payment network, the machine-readable code to the user device.

5. The computer-implemented method of claim 4, further comprising:
receiving, by the payment network, the transaction authorization request in response to the acceptance device registering the machine-readable code;
verifying, by the payment network, the machine-readable code; and
completing, by the payment network, the transaction authorization request based on the verification of the machine-readable code.

6. The computer-implemented method of claim 5, wherein the user input comprises a selection of the cryptocurrency account information, and wherein completion of the transaction authorization request based on the verification of the machine-readable code comprises causing the cryptocurrency exchange to debit the digital asset account based on the verification of the machine-readable code.

7. The computer-implemented method of claim 5, wherein the user input comprises a selection of the fiat-based account information, and wherein completion of the transaction request based on the verification of the machine-readable code comprises causing the issuer system to debit the fiat-based asset account based on the verification of the machine-readable code.

8. The computer-implemented method of claim 1, further comprising:
receiving, by the payment network, a purchase request for a digital asset;
verifying, by the payment network, that the token is linked to the unique identifier; and
initiating, by the payment network, fulfillment of the purchase request via the cryptocurrency exchange based on the verification that the token is linked to the unique identifier.

9. A payment network communicably coupled to a plurality of financial institution systems, wherein the plurality of financial institution systems comprises a cryptocurrency exchange configured to host a digital asset account, and an issuer system configured to host a fiat-based asset account, the payment network comprising:
a tokenization engine configured to:
receive cryptocurrency account information associated with the digital asset account from the cryptocurrency exchange;
generate a token associated with the cryptocurrency account information;
receive a unique identifier associated with the fiat-based asset account hosted by the issuer system;
link the token to the unique identifier; and
a token vault configured to:
receive the token from the tokenization engine; and
store the token.

10. The payment network of claim 9, wherein the payment network is communicably coupled to a user device via an application program interface (API) integrated into a financial mobile application accessed by the user device, and wherein the tokenization engine is further configured to:
receive a token request from the user device via the API;
identify the token stored in the token vault based on the token request; and
transmit the token from the token vault to the user device via the API, in response to the token request.

11. The payment network of claim 10, wherein the payment network is configured to:
receive a user input from the user device via the API;
generate a machine-readable code associated with the token based on the user input, wherein the machine-readable code is configured to initiate a transaction authorization request when registered by an acceptance device; and
transmit the machine-readable code to the user device via the API.

12. The payment network of claim 11, wherein the payment network is configured to:
receive the transaction authorization request in response to the acceptance device registering the machine-readable code;
verify the machine-readable code; and
complete the transaction authorization request based on the verification of the machine-readable code.

13. The payment network of claim 12, wherein the user input comprises a selection of the cryptocurrency account information, and wherein completion of the transaction authorization request based on the verification of the machine-readable code comprises causing the cryptocurrency exchange to debit the digital asset account based on the verification of the machine-readable code.

14. The payment network of claim 12, wherein the user input comprises a selection of fiat-based account information associated with the unique identifier, and wherein completion of the transaction authorization request based on the verification of the machine-readable code comprises causing the issuer system to debit the fiat-based asset account based on the verification of the machine-readable code.

15. The payment network of claim 10, wherein the payment network is configured to:
receive a purchase request for a digital asset from the user device via the API;
verify that the token is linked to the unique identifier; and
initiate fulfillment of the purchase request via the cryptocurrency exchange based on the verification that the token is linked to the unique identifier.

16. A system, comprising:
a payment network communicably coupled to a plurality of financial institution systems, wherein the plurality of financial institution systems comprises a cryptocurrency exchange configured to host a digital asset account, and an issuer system configured to host a fiat-based asset account, wherein the payment network is configured to:
receive cryptocurrency account information associated with the digital asset account from the cryptocurrency exchange;
generate a token associated with the cryptocurrency account information;
receive a unique identifier associated with the fiat-based asset account hosted by the issuer system;
link the token to the unique identifier; and
store the token; and
a financial mobile application, installable on a user device including a processor and a memory, the financial mobile application including an application program interface (API) communicably couplable to the payment network, wherein the API is configured to cause the user device to:
receive the token from the payment network;
display the cryptocurrency account information based on the token; and
display fiat-based account information based on the token, wherein the account information is associated with the unique identifier.

17. The system of claim 16, wherein the financial mobile application comprises a user interface, and wherein the API is configured to cause the user device to:
receive a user input via the user interface of the financial mobile application, wherein the user input comprises a selection of the cryptocurrency account information; and
transmit the user input to the payment network via the API.

18. The system of claim 17, wherein the payment network is configured to:
receive the user input from the user device via the API;
generate a machine-readable code associated with the token based on the user input, wherein the machine-readable code is configured to initiate a transaction authorization request when registered by an acceptance device; and
transmit the machine-readable code to the user device.

19. The system of claim 18, wherein the payment network is configured to:
receive the transaction authorization request in response to the acceptance device registering the machine-readable code;
verify the machine-readable code; and
complete the transaction authorization request based on the verification of the machine-readable code, wherein completion of the transaction authorization request comprises causing the cryptocurrency exchange to debit the digital asset account based on the verification of the machine-readable code.

20. The system of claim 16, wherein the payment network is configured to:
receive a purchase request for a digital asset from the user device via the API;
verify that the token is linked to the unique identifier; and
initiate fulfillment of the purchase request via the cryptocurrency exchange based on the verification that the token is linked to the unique identifier.
